(19) United States
(12) Patent Application Publication
(10) Pub. No.: US 2025/0030459 A1
(43) Pub. Date: Jan. 23, 2025

(54) MULTI-AP COORDINATION METHOD BASED ON LOCATION OR MOBILITY OF TERMINAL AND ELECTRONIC DEVICE

(71) Applicant: SAMSUNG ELECTRONICS CO., LTD., Suwon-si (KR)

(72) Inventors: Hyeonu CHOI, Suwon-si (KR); Junsu CHOI, Suwon-si (KR)

(21) Appl. No.: 18/817,781

(22) Filed: Aug. 28, 2024

Related U.S. Application Data
(63) Continuation of application No. PCT/KR2024/007245, filed on May 28, 2024.

(30) Foreign Application Priority Data
Jul. 21, 2023 (KR) 10-2023-0095471
Sep. 4, 2023 (KR) 10-2023-0116986

(51) Int. Cl. H04B 7/026; H04B 7/06; H04L 5/00

(52) U.S. Cl. CPC H04B 7/026; H04B 7/0617; H04B 7/0626; H04L 5/006

(57) ABSTRACT

An electronic device may include a processor, a wireless communication module operatively connected to the processor configured to transmit and receive a wireless signal, and a memory configured to store instructions. The instructions may be executed by the processor to cause the device to receive a null data packet announcement (NDPA) frame or a null data packet (NDP) frame. The instructions may be executed by the processor to cause the electronic device to receive a beamforming report poll (BFRP) frame. The instructions may be executed by the processor to cause the electronic device to transmit a feedback frame containing the channel state information based on the BFRP frame. The instructions may be executed by the processor to cause the electronic device to perform communication through a combination of one or more access points (APs) determined based on the feedback frame in a network environment for multi-AP coordination.

### CROSS-REFERENCE TO RELATED APPLICATIONS

This application is a continuation application of International Application No. PCT/KR2024/007245 designating the United States, filed on May 28, 2024, in the Korean Intellectual Property Receiving Office and claiming priority to Korean Patent Application No. 10-2023-0095471, filed on Jul. 21, 2023, and Korean Patent Application No. 10-2023-0116986, filed on Sep. 4, 2023, in the Korean Intellectual Property Office, the disclosures of which are incorporated by reference herein in their entireties.

### BACKGROUND

### Field

Embodiments of the present disclosure relate to a multi-access point (AP) coordination method based on the location or mobility of a terminal and an electronic device.

### Description of Related Art

Wireless-Fidelity (Wi-Fi) has grown in popularity over the last decade with the emergence of mobile devices such as laptops, smartphones, and tablets. With the wide use of Wi-Fi, the demand for faster wireless networks has also increased, and as a result, Wi-Fi has evolved from generation to generation. The latest Wi-Fi technology that has currently been standardized and commercialized is Wi-Fi 6, and standardization for the next-generation technology standard, Wi-Fi 7, is currently in progress in the task group.

Discussions regarding the forthcoming standards after Wi-Fi 7 also began in early 2023, and what features will potentially be introduced into these standards are being discussed at the study group stage, which is the stage before the task group where the actual standard establishment stage is carried out. Various techniques are being discussed as candidate techniques, and one of the major technologies that is likely to be included in the standards is multi-access point (AP) coordination. In multi-AP coordination, an electronic device transmits and receives data to and from a plurality of APs.

The above information may be presented as the related art to help with the understanding of the disclosure. No arguments or decisions are made as to whether any of the above is applicable as prior art related to the disclosure.

The technical goals to be achieved are not limited to those described above, and other technical goals not mentioned above are clearly understood by one of ordinary skill in the art from the following description.

### SUMMARY

According to an embodiment, an electronic device may include a processor, a wireless communication circuit operatively connected to the processor and configured to transmit and receive a wireless signal, and a memory configured to store instructions. The instructions may be executed individually or collectively by the processor to cause the electronic device to receive a null data packet announcement (NDPA) frame notifying channel sounding. The instructions may be executed individually or collectively by the processor to cause the electronic device to receive a null data packet (NDP) frame. The instructions may be executed individually or collectively by the processor to cause the electronic device to obtain channel state information based on the NDP frame. The instructions may be executed individually or collectively by the processor to cause the electronic device to receive a beamforming report poll (BFRP) frame. The instructions may be executed individually or collectively by the processor to cause the electronic device to transmit a feedback frame containing the channel state information based on the BFRP frame. The instructions may be executed individually or collectively by the processor to cause the electronic device to perform communication through a combination of one or more access points (APs) determined based on the feedback frame in a network environment for multi-AP coordination.

According to an embodiment, a communication device for controlling multi-AP coordination may include a processor, a wireless communication circuit operatively connected to the processor and configured to transmit and receive a wireless signal, and a memory configured to store instructions. The instructions may be executed individually or collectively by the processor to cause the communication device to collect feedback frames according to channel sounding between APs capable of participating in multi-AP coordination and an electronic device. The instructions may be executed individually or collectively by the processor to cause the communication device to determine a combination of one or more APs to communicate with the electronic device based on the feedback frames.

According to an embodiment, an operating method of an electronic device may include receiving an NDPA frame notifying channel sounding. The operating method may include receiving an NDP frame. The operating method may include obtaining channel state information based on the NDP frame. The operating method may include receiving a BFRP frame. The operating method may include transmitting a feedback frame containing the channel state information based on the BFRP frame. The operating method may include performing communication through a combination of one or more APs determined based on the feedback frame in a network environment for multi-AP coordination.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 illustrates an example of a wireless local area network (WLAN) system according to an embodiment;

FIG. 2 illustrates an example of a WLAN system according to an embodiment;

FIG. 3 is a diagram illustrating an example of a link setup operation according to an embodiment;

FIG. 4 is a diagram illustrating multi-access point (AP) coordination according to an embodiment;

FIGS. 5A to 5C are diagrams illustrating examples of networks in which multi-AP coordination operates according to an embodiment;

FIG. 6 is a diagram illustrating multi-AP coordination using channel sounding according to an embodiment;

FIGS. 7A and 7B are diagrams illustrating examples of channel sounding protocols in a network for multi-AP coordination according to an embodiment;

FIGS. 8 and 9 are diagrams illustrating example of a method of controlling multi-AP coordination using channel sounding according to an embodiment;

FIG. 10 is a diagram illustrating an operation of a station (STA) for multi-AP coordination according to an embodiment;

FIGS. 11A to 11C are diagrams illustrating frames defined to transfer a report of state information of STA according to an embodiment;

FIG. 12 is a diagram illustrating an example of controlling multi-AP coordination using channel sounding according to an embodiment;

FIG. 13 is a diagram illustrating an example of controlling multi-AP coordination using channel sounding according to an embodiment;

FIG. 14 is a schematic block diagram of a WLAN system for multi-AP coordination according to an embodiment; and

FIG. 15 is a block diagram of an electronic device in a network environment according to an embodiment.

### DETAILED DESCRIPTION

Hereinafter, embodiments will be described in detail with reference to the accompanying drawings. When describing the embodiments with reference to the accompanying drawings, like reference numerals refer to like components, and any repeated description related thereto will be omitted.

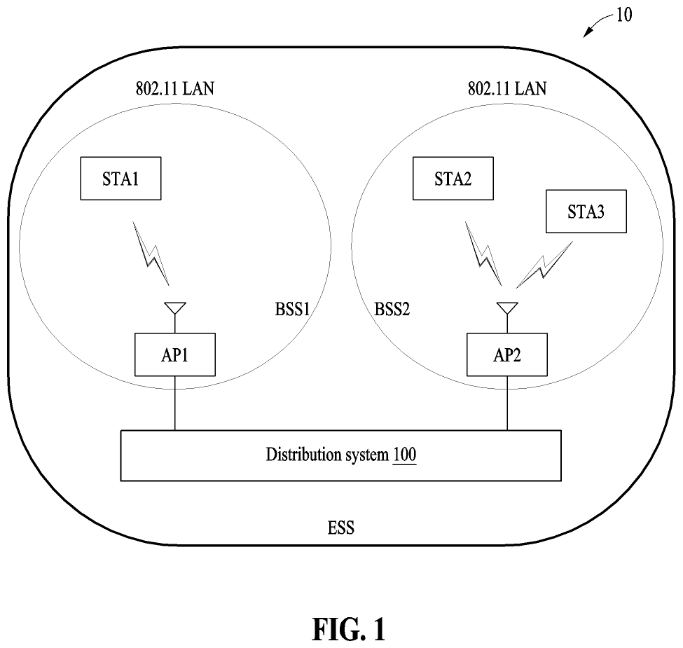

FIG. 1 is a diagram illustrating an example of a wireless local area network (WLAN) system according to an embodiment.

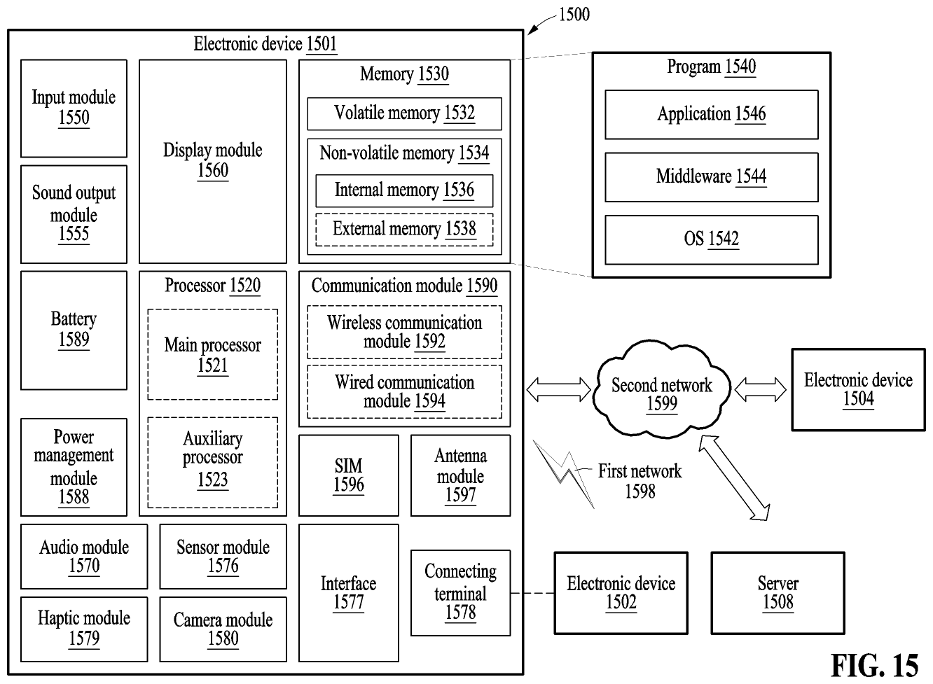

Referring to FIG. 1, according to an embodiment, a WLAN system 10 may refer to an infrastructure mode in which an access point (AP) is present in the structure of a wireless local area network (WLAN) of the Institute of Electrical and Electronic Engineers (IEEE) 802.11 standard. The WLAN system 10 may include one or more basic service sets (BSSs) (e.g., BSS1 and BSS2). The BSS (e.g., BSS1 or BSS2) may refer to a set of APs and STAs (e.g., an electronic device 1501, an electronic device 1502, and an electronic device 1504 of FIG. 15) that may communicate with each other with a successful synchronization. The BSS1 may include an AP1 and an STA1, and the BSS2 may include an AP2, an STA2, and an STA3.

According to an embodiment, the WLAN system 10 may include at least one STA (e.g., STA1 to STA3), a plurality of APs (e.g., AP1 and AP2) providing a distribution service, and a distribution system 100 connecting the plurality of APs (e.g., AP1 and AP2). The distribution system 100 may implement an extended service set (ESS), which is a service set extended by connecting a plurality of BSSs (e.g., BSS1 and BSS2). The ESS may be used as a term referring to one network in which the plurality of APs (e.g., AP1 and AP2) are connected through the distribution system 100. The plurality of APs (e.g., AP1 and AP2) included in one ESS may have the same service set identification (SSID).

According to an embodiment, the STA (e.g., STA1 to STA3) may be an arbitrary functional medium including a medium access control (MAC) and a physical layer interface for a wireless medium that conform to the provisions of the IEEE 802.11 standard. The term “STA” (e.g., STA1 to STA3) may be used as including both an AP-STA and a non-AP STA. The STA (e.g., STA1 to STA3) may be referred to by various names, such as an electronic device, a mobile terminal, a wireless device, a wireless transmit/receive unit (WTRU), a user equipment (UE), a mobile station (MS), a mobile subscriber unit, or simply, a user.

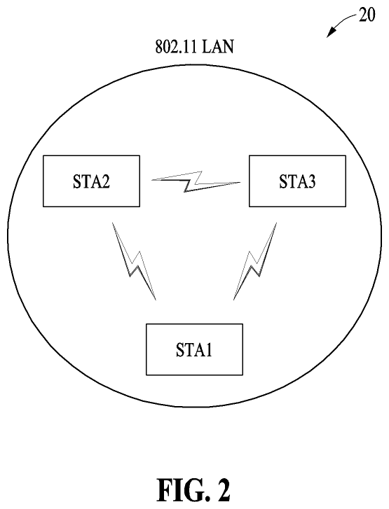

FIG. 2 is a diagram illustrating an example of a WLAN system according to an embodiment.

Referring to FIG. 2, according to an embodiment, a WLAN system 20 may represent an ad-hoc mode in which a network is established and communicated between a plurality of STAs (e.g., STA1 to STA3) without any AP in the structure of a WLAN of the IEEE 802.11 standard, as opposed to the WLAN system 10 of FIG. 1. The WLAN system 20 may include a BSS operating in an ad-hoc mode, for example, an independent basic service set (IBSS).

According to an embodiment, the IBSS does not include any AP, and therefore, it may not include a centralized management entity that performs a central management function. In the IBSS, the STAs may be managed in a distributed manner. In the IBSS, all the STAs may be mobile STAs and may form a self-contained network (or an integrated network) because access to a distribution system is not allowed.

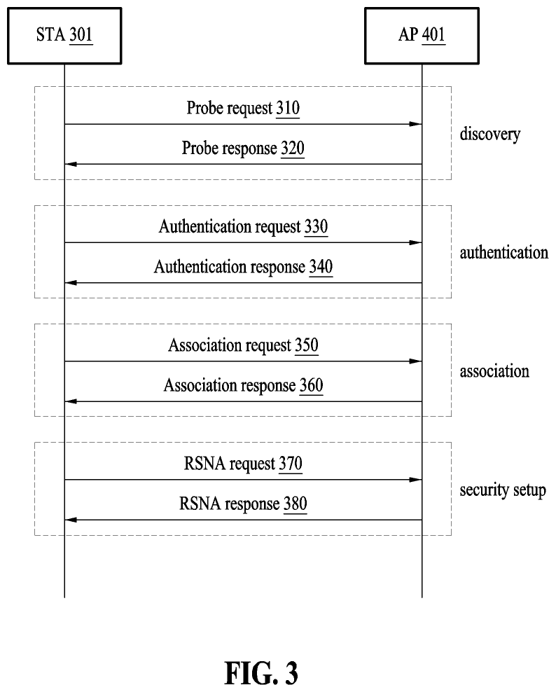

FIG. 3 is a diagram illustrating an example of a link setup operation according to an embodiment.

Referring to FIG. 3, according to an embodiment, the link setup operation may be performed between devices (e.g., STA 301 and AP 401) to communicate with each other. For the link setup, operations for network discovery, execution of authentication, establishing association, and setting the security may be performed. The link setup operation may be referred to as a session initiation operation or a session setup operation. Further, the operations of discovery, authentication, association, and setting security of the link setup operation may be collectively referred to as an association operation.

According to an embodiment, the network discovery operation may include operation 310 and operation 320. In operation 310, the STA 301 (e.g., the electronic device 1501, the electronic device 1502, or the electronic device 1504 of FIG. 15) may transmit a probe request frame to probe which AP exists and may wait for a response to the probe request frame. The STA 301 may find a network to participate in by performing a scanning operation to access the network. The probe request frame may include information of the STA 301 (e.g., device name and/or address of the STA 301). The scanning operation in operation 310 may refer to an active scanning operation. In operation 320, the AP 401 may transmit a probe response frame to the STA 301 that has transmitted the probe request frame, in response to the probe request frame. The probe response frame may include information of the AP 401 (e.g., device name and/or network information of the AP 401). While FIG. 3 shows that the network discovery operation is performed through active scanning, the disclosure is not necessarily limited thereto. In case that the STA 301 performs passive scanning, the operation of transmitting the probe request frame may be omitted. The STA 301 that performs passive scanning may receive a beacon frame transmitted by the AP 401 and perform the following subsequent procedures.

According to an embodiment, after the STA 301 discovers the network, an authentication operation including operation 330 and operation 340 may be performed. In operation 330, the STA 301 may transmit an authentication request frame to the AP 401. In operation 340, the AP 401 may determine whether to allow authentication for the corresponding STA 301 based on information contained in the authentication request frame. The AP 401 may provide a result of the authentication processing to the STA 301 via an authentication response frame. The authentication frame used for the authentication request/response may correspond to a management frame.

According to an embodiment, the authentication frame may include information about an authentication algorithm number, an authentication transaction sequence number, a status code, a challenge text, a robust security network (RSN), or a finite cyclic group.

According to an embodiment, after successful authentication of the STA 301, an association operation including operation 350 and operation 360 may be performed. In operation 350, the STA 301 may transmit an association request frame to the AP 401. In operation 360, the AP 401 may transmit an association response frame to the STA 301 in response to the association request frame.

According to an embodiment, the association request frame and/or the association response frame may include information related to various capabilities. For example, the association request frame may include information related to: a beacon listening interval, a service set identifier (SSID), supported rates, supported channels, an RSN, a mobility domain, supported operating classes, a traffic indication map (TIM) broadcast request, and/or information related to an interworking service capability. For example, the association response frame may include information related to various capabilities, a status code, association ID (AID), supported rates, an enhanced distributed channel access (EDCA) parameter set, a received channel power indicator (RCPI), a received signal-to-noise indicator (RSNI), a mobility domain, a timeout interval (e.g., an association comeback time), an overlapping BSS scan parameter, a TIM broadcast response, and/or information such as a QoS map.

According to an embodiment, after the STA 301 is successfully associated with the network, a security setup operation including operation 370 and operation 380 may be performed. The security setup operation may be performed through a robust security network association (RSNA) request/response. For example, the security setup operation may include an operation of performing private key setup by means of a 4-way handshaking through an extensible authentication protocol over LAN (EAPOL) frame. The security setup operation may be performed according to a security scheme that is not defined in the IEEE 802.11 standard.

According to an embodiment, a security session may be established between the STA 301 and the AP 401 according to the security setup operation, and the STA 301 and the AP 401 may proceed with secure data communication.

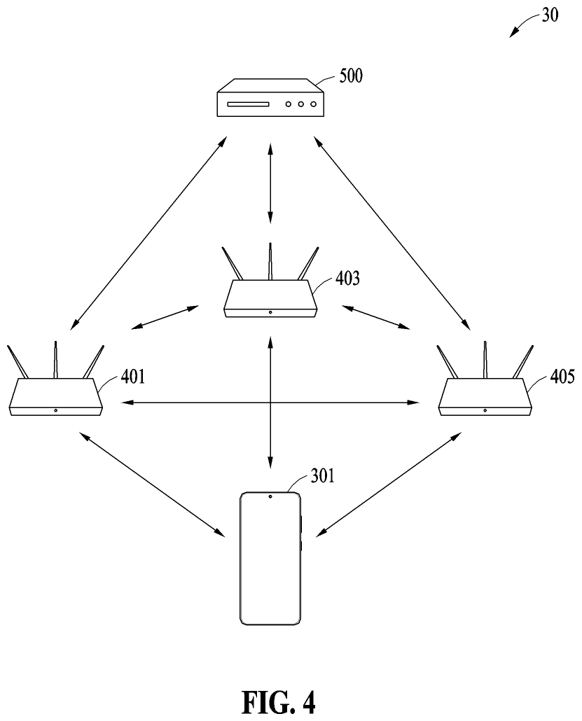

FIG. 4 is a diagram illustrating multi-access point (AP) coordination according to an embodiment.

Referring to FIG. 4, a WLAN system 30 (e.g., the WLAN system 10 of FIG. 1 or the WLAN system 20 of FIG. 2) may include at least one STA (e.g., the STA 301), a plurality of APs (e.g., the AP 401, an AP 403, and/or an AP 405), and a communication device 500. In the WLAN system 30, multi-AP coordination may be performed. Multi-AP coordination may be a method of transmitting a signal to an STA (e.g., the STA 301) using a plurality of APs (e.g., the AP 401, the AP 403, and the AP 405). For example, while connected to the AP 401, the STA 301 may transmit and receive data to and from at least two APs among the AP 401, the AP 403, and the AP 405. In multi-AP coordination, a signal from the AP 403 and/or the AP 405 is no longer interference with the STA 301 connected to the AP 401, but instead becomes a desired signal. Multi-AP coordination may include transmission methods such as distributed multiple-input multiple-output (MIMO), coded orthogonal frequency division multiple access (C-OFDMA), coordinated beamforming, and coordinated spatial reuse. Although FIG. 4 shows that three APs, the AP 401, the AP 403, and the AP 405, are used in multi-AP coordination, embodiments are not necessarily limited thereto, and the number of APs in multi-AP coordination may be more than four according to an embodiment. Multi-AP coordination is not limited to the structure shown in FIG. 4 and may be performed in various forms.

According to an embodiment, multi-AP coordination may minimize the interference between BSSs during data transmission and reception by, during data transmission and reception between an STA (e.g., the STA 301) and APs (e.g., the AP 401, the AP 403, and the AP 405), sharing information (e.g., link information, channel feedback information, and scheduling information) about the STA, which is necessary or optimal for multi-AP coordination between the APs (e.g., the AP 401, the AP 403, and the AP 405). or which may increase the data transmission efficiency, for example, by allowing two or more APs (e.g., at least two APs among the AP 401, the AP 403, and the AP 405) to participate at a predetermined time in data transmission and reception for the STA (e.g., the STA 301). To transmit data using a plurality of APs (e.g., the AP 401, the AP 403, and the AP 405) simultaneously in the WLAN system 30, a multi-AP coordination environment may need to be created to coordinate the plurality of APs (e.g., the AP 401, the AP 403, and the AP 405). To coordinate the APs, links may need to be established between the APs (e.g., the AP 401, the AP 403, and the AP 405), and information necessary for multi-AP coordination, such as information (e.g., link information, channel feedback information, and scheduling information) about the STA (e.g., the STA 301) associated with the respective APs (e.g., the AP 401, the AP 403, and the AP 405), may need to be shared.

According to an embodiment, the communication device 500 may manage and control (or coordinate) the plurality of APs (e.g., the AP 401, the AP 403, and the AP 405) present in the WLAN system 30. The communication device 500 may manage information on a BSS formed by each of the plurality of APs (e.g., the AP 401, the AP 403, and the AP 405) and/or information about an STA associated with the BSS.

According to an embodiment, the communication device 500 may initiate and control multi-AP coordination. For example, the communication device 500 may group or select APs (e.g., the AP 401, the AP 403, and the AP 405) to perform multi-AP coordination with the STA 301, and may manage the links with the APs (e.g., the AP 401, the AP 403, and the AP 405) to perform multi-AP coordination so that information may be shared between the APs (e.g., the AP 401, the AP 403, and the AP 405) to perform multi-AP coordination.

According to an embodiment, the APs (e.g., the AP 401, the AP 403, and the AP 405) may perform the same function as an AP capable of forming a BSS in the WLAN system 30, may be coordinated by the communication device 500, and may participate in multi-AP coordination. For example, the APs (e.g., the AP 401, the AP 403, and the AP 405) may establish an association with the communication device 500, and may share information (e.g., control information, management information, and data traffic) with the communication device 500.

According to an embodiment, the STA 301 may be associated with one AP (e.g., the AP 401) among the APs (e.g., the AP 401, the AP 403, and the AP 405) that are participating in multi-AP coordination. In multi-AP coordination, the APs (e.g., the AP 401, the AP 403, and the AP 405) may be capable of direct transmission and reception with the communication device 500, and the STA 301 may be capable of direct transmission and reception with the APs (e.g., the AP 401, the AP 403, and the AP 405) that are participating in multi-AP coordination. Although FIG. 4 does not actively depict the communication device 500 and the STA 301 being capable of direct transmission and reception with each other, the communication device 500 may recognize the presence of the STA 301. According to an embodiment, the communication device 500 and the STA 301 may be capable of direct transmission and/or reception with each other.

According to an embodiment, the communication device 500 may be referred to as an AP controller, a master AP, and/or a sharing AP. The communication device 500 is a device configured to control multi-AP coordination and may be referred to by various terms. APs (e.g., the AP 401, the AP 403, and the AP 405) capable of participating in multi-AP coordination may be referred to as slave APs or shared APs. APs (e.g., the AP 401, the AP 403, and the AP 405) capable of participating in multi-AP coordination are devices to perform multi-AP coordination under the control of the communication device 500 and may be replaced with various terms.

According to an embodiment, multi-AP coordination may benefit user experience in that it may maintain latency that is not constant due to interference or fading to be consistent. In a network that supports multi-AP coordination, the STA 301 may be capable of data transmission and reception together with the plurality of APs (e.g., the AP 401, the AP 403, and the AP 405), thereby increasing overall network capacity and providing an uninterrupted communication service even while the STA 301 is moving. In addition, in the network, more client terminals may be accommodated and communication delay at a wireless end may be reduced by finely coordinating the distribution of radio resources.

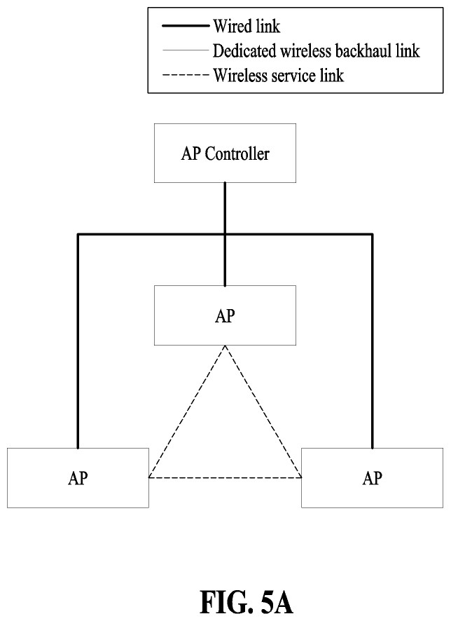

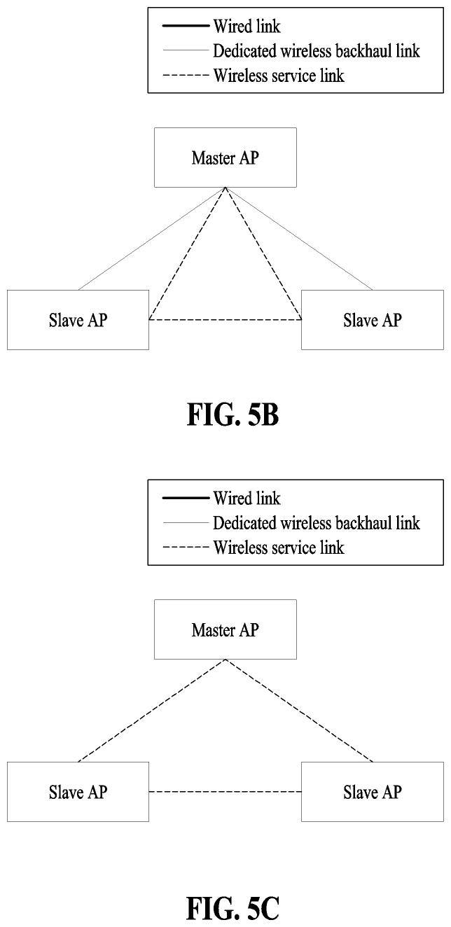

FIGS. 5A to 5C are diagrams illustrating examples of networks in which multi-AP coordination operates according to an embodiment.

According to an embodiment, examples of networks in which multi-AP coordination operates may be as shown in FIGS. 5A to 5C. A network in which multi-AP coordination operates may be implemented in the form of an enterprise network as in FIG. 5A and/or in the form of a mesh network as in FIG. 5B or 5C.

Referring to FIG. 5A, according to an embodiment, a network in which multi-AP coordination operates may be implemented in the form of an enterprise network. The communication device 500 to control multi-AP coordination and the APs (e.g., the AP 401, the AP 403, and the AP 405) participating in multi-AP coordination of FIG. 4 may be substantially the same as an AP controller and APs of FIG. 5A, respectively. An interface for information exchange between the AP controller and the APs may be implemented as a wired link, and an interface for information exchange between the APs may be implemented as a wireless link (e.g., a wireless service link).

Referring to FIGS. 5B and 5C, according to an embodiment, a network in which multi-AP coordination operates may be implemented in the form of a mesh network. The communication device 500 to control multi-AP coordination and the APs (e.g., the AP 401, the AP 403, and the AP 405) participating in multi-AP coordination of FIG. 4 may be substantially the same as a master AP and slave APs of FIG. 5B or 5C, respectively. An interface for information exchange between the master AP and the slave APs may be implemented as a dedicated wireless link (e.g., a dedicated wireless backhaul link) and/or a wireless link (e.g., a wireless service link). In the network of FIG. 5B or 5C, the master AP may control the slave APs participating in multi-AP coordination and at the same time, participate in multi-AP coordination together with the slave APs.

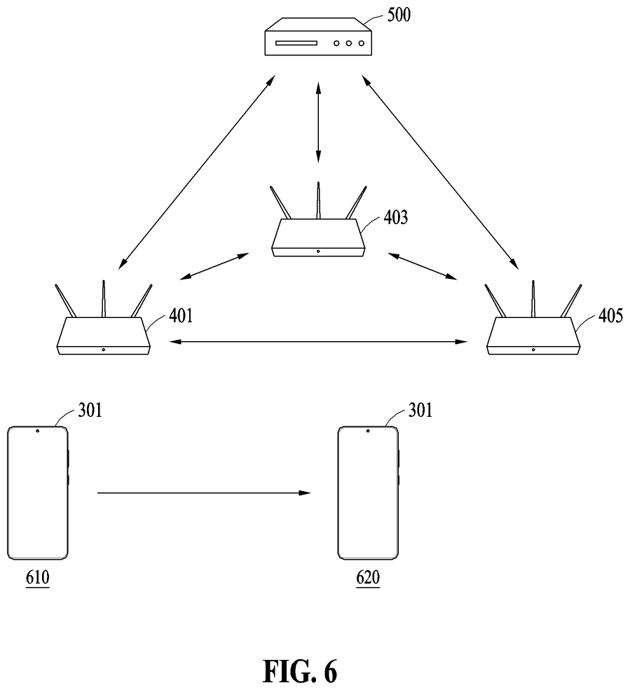

FIG. 6 is a diagram illustrating multi-AP coordination using channel sounding according to an embodiment.

Referring to FIG. 6, according to an embodiment, in a network that supports multi-AP coordination, due to the characteristic that data of the STA 301, which is a client, is transmitted through a plurality of APs (e.g., at least two APs among the AP 401, the AP 403, and the AP 405), rather than a single AP (the AP 401, the AP 403, or the AP 405), the more clients accessing the network in addition to the STA 301, the more data may need to be buffered. Thus, the burden on the backhaul network may increase, and the memory size of APs may limit the network performance. In addition, depending on the location or mobility situation of the STA 301, which is the client, data communication through a single AP (e.g., the AP 401, the AP 403, or the AP 405) may be required, or data communication through a plurality of APs (e.g., at least two APs among the AP 401, the AP 403, and the AP 405) may be required. Depending on the location or mobility situation of the STA 301, data communication through a single AP (e.g., the AP 401, the AP 403, or the AP 405) may enable a service sufficiently, and may be better in terms of performance and system efficiency. Switch therebetween (e.g., between communication through a single AP and communication through a plurality of APs) should be performed accurately and fast to prevent a decrease in the network operation efficiency. That is, in a network that supports multi-AP coordination, efficient control (e.g., transmission at a time needed and/or transmission of as much data as needed, and/or transmission using only an AP needed) may be required depending on the situation.

According to an embodiment, the communication device 500 (e.g., the AP controller of FIG. 5A and the master AP of FIG. 5B or 5C) may verify the location and/or mobility situation of the STA 301 for efficient control in a network that supports multi-AP coordination, and determine (or select) a combination of one or more APs to participate in data transmission and reception in the network environment for multi-AP coordination (e.g., an optimal combination of APs to communicate with the STA 301). The combination of one or more APs may include a single AP and/or a multi-AP combination. Allowing the communication device 500 to distribute data to the APs based on the location and/or mobility situation of the STA 301 may reduce the burden on the backhaul network and effectively operate the wireless link.

According to an embodiment, the location and/or mobility situation of the STA 301 may be verified through channel sounding (or a channel sounding operation). Channel sounding may refer to a series of operations of collecting channel information (e.g., channel state information for a wireless channel) before a transmitting party transmits data, in order to ensure that data may be transmitted accurately to a receiving party. A channel sounding protocol may refer to a procedure of feeding back-channel state information (CSI) between a beamformer (or an AP) (e.g., the communication device 500, the AP 401, the AP 403, and the AP 405) and a beamformee (or a non-AP STA) (e.g., the STA 301). The beamformee (e.g., the STA 301) may measure a signal (e.g., a null data packet (NDP)) agreed between the beamformer (e.g., the communication device 500, the AP 401, the AP 403, and the AP 405) and the beamformee (e.g., the STA 301), and generate CSI by checking the difference between the “actually received NDP” and a “reference NDP”. The beamformee (e.g., the STA 301) may convert the CSI into a signal-to-noise ratio (SNR) (e.g., an average SNR), and transmit a feedback frame containing the SNR to the beamformer (e.g., the communication device 500, the AP 401, the AP 403, and the AP 405). For example, the beamformee (e.g., the STA 301) may feed back the CSI in the form of a compressed beamforming report. The beamformee (e.g., the STA 301) may convert the CSI into the form of an average SNR and a V-matrix through singular value decomposition (SVD) and feed back a compressed beamforming frame. The compressed beamforming frame may include information such as an SNR value for a space-time stream and a compressed beamforming feedback matrix for a subcarrier. Table 1 shows an example of the structure of a compressed beamforming report field (e.g., 40 MHz) forming a compressed beamforming frame.

TABLE 1

| | Size | |
|---|---|---|
| Field | (bit) | Meaning |
| SNR in space-time stream 1 | 8 | Average signal-to-noise ratio in the |
| | | STA sending the report for space- |
| | | time stream 1. |
| . . . | | |
| SNR in space-time stream Nc | 8 | Average signal-to-noise ratio in the |
| | | STA sending the report for space- |
| | | time stream Nc. |
| Beamforming Feedback Matrix | Na × (b_{ψ} + b_{ϕ})/2 | Beamforming feedback matrix V. |
| V for carrier −58 | | |
| Beamforming Feedback Matrix | Na × (b_{ψ} + b_{ϕ})/2 | Beamforming feedback matrix V. |
| V for carrier −58 + Ng | | |
| . . . | | |
| Beamforming Feedback Matrix | Na × (b_{ψ} + b_{ϕ})/2 | Beamforming feedback matrix V. |
| V for carrier −2 | | |
| Beamforming Feedback Matrix | Na × (b_{ψ} + b_{ϕ})/2 | Beamforming feedback matrix V. |
| V for carrier 2 | | |
| Beamforming Feedback Matrix | Na × (b_{ψ} + b_{ϕ})/2 | Beamforming feedback matrix V. |
| V for carrier 2 + Ng | | |
| . . . | | |
| Beamforming Feedback Matrix | Na × (b_{ψ} + b_{ϕ})/2 | Beamforming feedback matrix V. |
| V for carrier 58 | | |

According to an embodiment, the communication device 500 may collect feedback frames according to channel sounding between the STA 301 and one or more devices capable of participating in multi-AP coordination. The one or more devices capable of participating in multi-AP coordination may include APs (e.g., the AP 401, the AP 403, and the AP 405) and/or the communication device 500. The APs (e.g., the AP 401, the AP 403, and the AP 405) may receive feedback frames according to channel sounding between the STA 301 and the APs (e.g., the AP 401, the AP 403, and the AP 405), and transmit the feedback frames to the communication device 500. The communication device 500 may obtain (e.g., collect) from the collected feedback frames, for example, SNR information of one or more devices capable of participating in multi-AP coordination from the perspective of the STA 301. The communication device 500 may verify the location and/or mobility situation of the STA 301 using the SNR information, and determine (or select) a combination of one or more APs to participate in data transmission and reception (e.g., an optimal combination of APs to communicate with the STA 301) in a network environment for multi-AP coordination. The communication device 500 may verify the location and/or mobility situation of the STA 301 through channel sounding without separate additional signaling. Here, in some embodiments, the “location” may not refer to an absolute geopolitical location, but refer to which AP's communication range the STA 301 is within. Since it only needs to verify which AP's communication range the STA 301 is within, the communication device 500 may select an AP to communicate with based on the SNR information, without needing to estimate the actual location of the STA 301.

According to an embodiment, the communication device 500 may continuously obtain (e.g., collect) SNR information of one or more devices capable of participating in multi-AP coordination from the perspective of the STA 301, and determine a combination of one or more APs to perform communication with the STA 301 based on the obtained SNR information. Hereinafter, the description will be provided assuming that the STA 301 moves from a location 610 to a location 620.

For example, a case where the STA 301 stays at the location 610 will be described. While the STA 301 stays at the location 610, the communication device 500 may verify that the SNRs of the AP 401/the AP 403/the AP 405 change little from SNR information measured through the STA 301, and determine that the STA 301 is in a stationary state. Since the measured SNRs are greater in the order of the AP 405<the AP 403<the AP 401, the communication device 500 may determine an AP to perform communication with the STA 301 to be the AP 401 solely.

For example, a case where the STA 301 moves from the location 610 in the direction of the location 620 will be described. While the STA 301 moves from the location 610 in the direction of the location 620, the communication device 500 may verify changes in that the SNR for the AP 401 decreases and the SNRs for the AP 403 and the AP 405 increase from the SNR information measured through the STA 301, and determine that the STA 301 is in a mobile state. The communication device 500 may determine APs to perform communication with the STA 301 to be a combination of the AP 401 and the AP 403. The communication device 500 may appropriately distribute data to the AP 401 and the AP 403 according to the location of the STA 301 when the STA 301 moves from the location 610 in the direction of the location 620. The communication device 500 may buffer the data to the AP 403 located in the direction approaching the STA 301 as well as the AP 401, thereby increasing latency and throughput performance.

For example, a case where the STA 301 stops moving at the location 620 will be described. When the STA 301 stops moving at the location 620, the communication device 500 may verify that the SNRs of the AP 401/the AP 403/the AP 405 change little from SNR information measured through the STA 301, and determine that the STA 301 is in a stationary state again. The communication device 500 may determine an AP to communicate with the STA 301 based on the SNRs of the AP 401/the AP 403/the AP 405 at the location 620. At this time, the communication device 500 may maintain the combination of the AP 401 and the AP 403 as before, or switch from the combination of the AP 401 and the AP 403 to the AP 403 solely or to a combination of the AP 403 and the AP 405.

For ease of description, FIG. 6 is described assuming a case where the communication device 500 is implemented as the AP controller in the enterprise network of FIG. 5A, but embodiments are not necessarily limited thereto. When the communication device 500 is implemented as the master AP in the mesh network of FIG. 5B or 5C, the communication device 500 may operate substantially identical to the disclosure above. Depending on the embodiment, the communication device 500 may perform channel sounding with the STA 301 and receive a feedback frame according to the channel sounding from the STA 301. The communication device 500 may further use the feedback frame between the communication device 500 and the STA 301, in addition to the feedback frame between the AP 401 and the STA 301, the feedback frame between the AP 403 and the STA 301, and the feedback frame between the AP 405 and the STA 301, to determine an AP to perform communication with the STA 301. The combination of one or more APs participating in data transmission and reception (e.g., an optimal combination of APs to communicate with the STA 301) in the network environment for multi-AP coordination may also include the communication device 500.

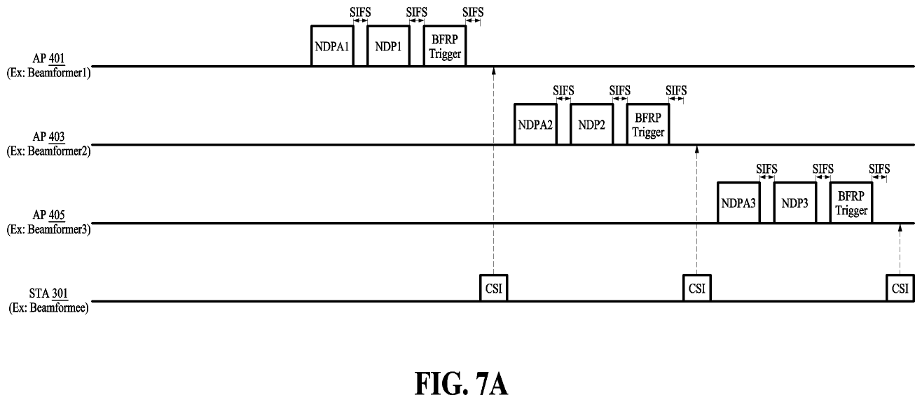

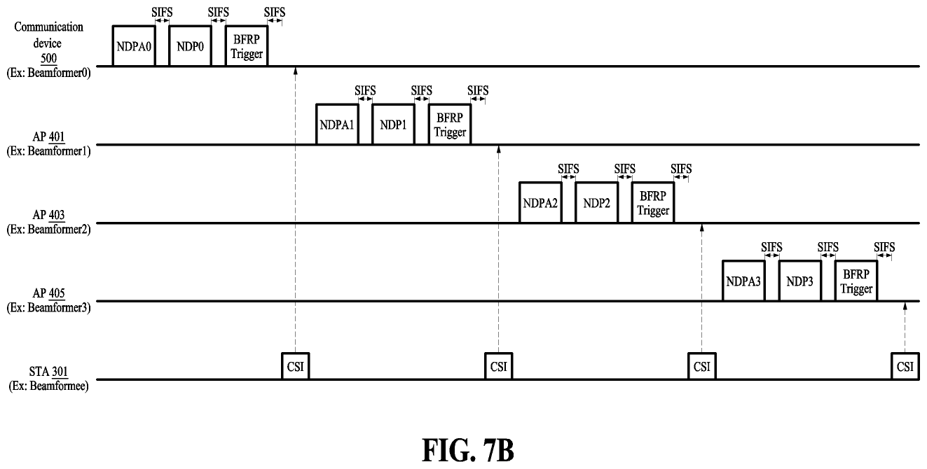

FIG. 7A is a diagram illustrating a channel sounding protocol in a network for multi-AP coordination according to an embodiment.

FIG. 7A may illustrate a channel sounding protocol when the communication device 500 to control multi-AP coordination is implemented as the AP controller in the enterprise network of FIG. 5A.

### (1) Channel Sounding Between AP 401 (e.g., Beamformer1) and STA 301 (e.g., Beamformee)

The AP 401 may transmit a null data packet announcement (NDPA) frame (NDPA1) notifying sounding transmission for feedback of the STA 301 to the STA 301. The NDPA frame refers to a control frame used to notify that channel sounding is initiated and a null data packet (NDP) frame is to be transmitted.

After transmitting the NDPA frame (NDPA1), the AP 401 may transmit an NDP frame (NDP1) to the STA 301 after a short interframe space (SIFS) time. The NDP frame may have a Very High Throughput (VHT) physical protocol data unit (PPDU) structure excluding the data field.

The STA 301 may obtain channel state information (e.g., downlink channel state information) by estimating a channel for the AP 401 based on the NDP frame (NDP1), and generate feedback information to be transmitted to the AP 401.

After transmitting the NDP frame (NDP1), the AP 401 may transmit a beamforming report poll (BFRP) trigger frame to the STA 301 after an SIFS time. The BFRP trigger frame may include information necessary to transmit feedback information (e.g., a feedback frame) (e.g., information about resources to be used for uplink transmission).

After receiving the BFRP trigger frame, the STA 301 may transmit a feedback frame (e.g., a compressed beamforming frame) containing feedback information to the AP 401 based on the BFRP trigger frame after an SIFS time.

### (2) Channel Sounding Between AP 403 (e.g., Beamformer2) and STA 301 (e.g., Beamformee)

The AP 403 may transmit an NDPA frame (NDPA2) notifying sounding transmission for feedback of the STA 301 to the STA 301. After transmitting the NDPA frame (NDPA2), the AP 403 may transmit an NDP frame (NDP2) to the STA 301 after an SIFS time.

The STA 301 may obtain channel state information (e.g., downlink channel state information) by estimating a channel for the AP 403 based on the NDP frame (NDP2), and generate feedback information to be transmitted to the AP 403.

After transmitting the NDP frame (NDP2), the AP 403 may transmit a BFRP trigger frame to the STA 301 after an SIFS time. After receiving the BFRP trigger frame, the STA 301 may transmit a feedback frame (e.g., a compressed beamforming frame) containing feedback information to the AP 403 based on the BFRP trigger frame after an SIFS time.

### (3) Channel Sounding Between AP 405 (e.g., Beamformer3) and STA 301 (e.g., Beamformee)

The AP 405 may transmit an NDPA frame (NDPA3) notifying sounding transmission for feedback of the STA 301 to the STA 301. After transmitting the NDPA frame (NDPA3), the AP 405 may transmit an NDP frame (NDP3) to the STA 301 after an SIFS time.

The STA 301 may obtain channel state information (e.g., downlink channel state information) by estimating a channel for the AP 405 based on the NDP frame (NDP3), and generate feedback information to be transmitted to the AP 405.

After transmitting the NDP frame (NDP3), the AP 405 may transmit a BFRP trigger frame to the STA 301 after an SIFS time. After receiving the BFRP trigger frame, the STA 301 may transmit a feedback frame (e.g., a compressed beamforming frame) containing feedback information to the AP 405 based on the BFRP trigger frame after an SIFS time.

In FIG. 7A, the beamformers (e.g., the AP 401, the AP 403, and the AP 405) may transmit signals in a broadcast manner and/or a unicast manner in channel sounding. Although FIG. 7A illustrates that the beamformers (e.g., the AP 401, the AP 403, and the AP 405) perform channel sounding while sequentially transmitting the NDPAs to the beamformee (e.g., the STA 301), the example is merely for ease of description, and the embodiments are not necessarily limited thereto. According to an embodiment, channel sounding may be performed while the beamformers (e.g., the AP 401, the AP 403, and the AP 405) transmit the NDPAs to the beamformee (e.g., the STA 301) at the same time. The beamformee (e.g., the STA 301) may measure the respective wireless signals (e.g., the NDP frames) of the beamformers (e.g., the AP 401, the AP 403, and the AP 405) at the same time and the same location, and transmit feedback information to the beamformers (e.g., the AP 401, the AP 403, and the AP 405). The communication device 500 may continuously collect SNR information of the beamformers (e.g., the AP 401, the AP 403, and the AP 405) at the same time from the perspective of the beamformee (e.g., the STA 301).

The communication device 500 may collect feedback frames according to channel sounding between the STA 301 and one or more devices (e.g., the AP 401, the AP 403, and the AP 405) capable of participating in multi-AP coordination. For example, the APs (e.g., the AP 401, the AP 403, and the AP 405) may receive feedback frames according to channel sounding between the STA 301 and the APs (e.g., the AP 401, the AP 403, and the AP 405), and transmit the feedback frames to the communication device 500. The communication device 500 may verify the location and/or mobility situation of the STA 301 based on the collected feedback frames (e.g., the feedback frame between the AP 401 and the STA 301, the feedback frame between the AP 403 and the STA 301, and the feedback frame between the AP 405 and the STA 301), and determine (or select) a combination of one or more APs to participate in data transmission and reception (e.g., an optimal combination of APs to communicate with the STA 301) in a network environment for multi-AP coordination.

FIG. 7B is a diagram illustrating a channel sounding protocol in a network for multi-AP coordination according to an embodiment.

FIG. 7B may illustrate a channel sounding protocol when the communication device 500 is implemented as the master AP in the mesh network of FIG. 5B or 5C.

In the channel sounding protocol of FIG. 7B, channel sounding between the communication device 500 and the STA 301 may be added, in addition to the channel sounding between the STA 301 (e.g., Beamformee) and the APs (e.g., the AP 401, the AP 403, and the AP 405) shown in FIG. 7A.

The communication device 500 may transmit an NDPA frame (NDPA0) notifying sounding transmission for feedback of the STA 301 to the STA 301. After transmitting the NDPA frame (NDPA0), the communication device 500 may transmit an NDP frame (NDP0) to the STA 301 after an SIFS time.

The STA 301 may obtain channel state information (e.g., downlink channel state information) by estimating a channel for the communication device 500 based on the NDP frame (NDP0), and generate feedback information to be transmitted to the communication device 500.

After transmitting the NDP frame (NDP0), the communication device 500 may transmit a BFRP trigger frame to the STA 301 after an SIFS time. After receiving the BFRP trigger frame, the STA 301 may transmit a feedback frame (e.g., a compressed beamforming frame) containing feedback information to the communication device 500 based on the BFRP trigger frame after an SIFS time.

Channel sounding between the STA 301 (e.g., Beamformee) and the APs (e.g., the AP 401, the AP 403, and the AP 405) of FIG. 7B may be performed as described with reference to FIG. 7A. A further description thereof will be omitted herein.

In FIG. 7B, the beamformers (e.g., the communication device 500, the AP 401, the AP 403, and the AP 405) may transmit signals in a broadcast manner and/or a unicast manner in channel sounding. Although FIG. 7B also illustrates that the beamformers (e.g., the communication device 500, the AP 401, the AP 403, and the AP 405) perform channel sounding while sequentially transmitting the NDPAs to the beamformee (e.g., the STA 301), this example is merely for ease of description, and the embodiments are not necessarily limited thereto. According to an embodiment, channel sounding may be performed while the beamformers (e.g., the communication device 500, the AP 401, the AP 403, and the AP 405) transmit the NDPAs to the beamformee (e.g., the STA 301) at the same time. The beamformee (e.g., the STA 301) may measure the respective wireless signals (e.g., the NDP frames) of the beamformers (e.g., the communication device 500, the AP 401, the AP 403, and the AP 405) at the same time and the same location, and transmit feedback information to the beamformers (e.g., the communication device 500, the AP 401, the AP 403, and the AP 405). The communication device 500 may continuously collect SNR information of the beamformers (e.g., the communication device 500, the AP 401, the AP 403, and the AP 405) at the same time from the perspective of the beamformee (e.g., the STA 301).

The communication device 500 may collect feedback frames according to channel sounding between the STA 301 and one or more devices (e.g., the AP 401, the AP 403, and the AP 405) capable of participating in multi-AP coordination. For example, the communication device 500 may verify the location and/or mobility situation of the STA 301 based on the collected feedback frames (e.g., the feedback frame between the communication device 500 and the STA 301, the feedback frame between the AP 401 and the STA 301, the feedback frame between the AP 403 and the STA 301, and the feedback frame between the AP 405 and the STA 301), and determine (or select) a combination of one or more APs to participate in data transmission and reception (e.g., an optimal combination of APs to communicate with the STA 301) in a network environment for multi-AP coordination.

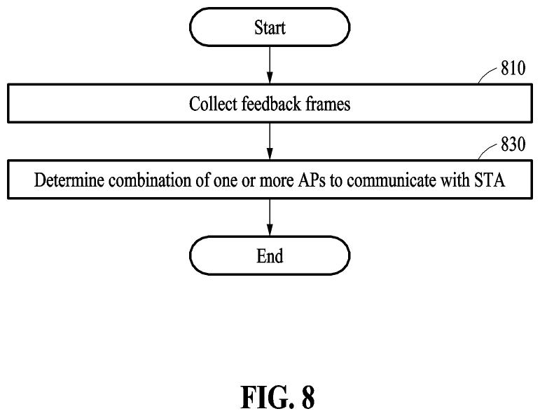

FIG. 8 is a diagram illustrating an example of a method of controlling multi-AP coordination using channel sounding according to an embodiment.

Referring to FIG. 8, operations 810 and 830 may be intended to describe the operation of the communication device 500 to autonomously control multi-AP coordination. Operations 810 and 830 may be sequentially performed, but are not necessarily performed sequentially. For example, the order of operations 810 and 830 may be changed, or operations 810 and 830 may be performed in parallel.

In operation 810, the communication device 500 may collect feedback frames for channel sounding transmitted from the STA 301. The feedback frames may include feedback frames between the STA 301 and one or more devices (e.g., the communication device 500, the AP 401, the AP 403, and the AP 405) capable of participating in multi-AP coordination. The one or more devices capable of participating in multi-AP coordination may include APs (e.g., the AP 401, the AP 403, and the AP 405) and/or the communication device 500. Channel sounding between the STA 301 and the one or more devices capable of participating in multi-AP coordination may be triggered according to a designated period and/or designated conditions (e.g., before data transmission). In addition, when it is determined that channel measurement (e.g., wireless channel measurement) is necessary, the communication device 500 may control channel sounding between the STA 301 and the one or more devices capable of participating in multi-AP coordination to be performed.

In operation 830, the communication device 500 may determine (or select) a combination of one or more APs to communicate with the STA 301 in a network environment for multi-AP coordination based on the collected feedback frames. The communication device 500 may obtain (e.g., collect), from the collected feedback frames, SNR information of one or more devices capable of participating in multi-AP coordination from the perspective of the STA 301, and verify the location and/or mobility situation of the STA 301 based on the obtained SNR information. The communication device 500 may switch, according to the location and/or mobility situation of the STA 301, the combination of one or more APs to communicate with the STA 301 from a single AP to a multi-AP combination, or from a multi-AP combination to a single AP, or from a first multi-AP combination to a second multi-AP combination.

Channel sounding is generally performed before traffic is transmitted and may be performed every few milliseconds (ms) (e.g., in some embodiments, about every 50 ms) if data is large and the channel changes significantly. The SNR measurement period required for the communication device 500 to verify the movement of the STA 301 may be determined according to the distance between APs, the moving speed of a person, and/or how quickly the movement of the STA 301 is desired to be detected. For example, assuming that the distance between APs is about 6 meters (m) and the typical walking speed is 1 meter/sec, if a movement of about 3 meters is the Maginot line for switching to a better AP, the location and mobility situation only need to be verified within around 3 seconds. If the received signal strength indicator (or received signal strength indication) (RSSI) needs to be measured at least three times to verify a change, then channel sounding once per second may be required. When the STA 301 moves during data transmission the change in the wireless channel increases and the AP performs channel sounding more frequently, and thus, the communication device 500 may sufficiently verify the location and mobility situation of the STA 301 within the required time. Channel sounding is not performed often when there is no traffic. In this case, since there is no data anyway, delay may not be a problem. Since an AP performs channel sounding before transmitting data while there is no traffic for a long time, the communication device 500 may verify the location and mobility situation of the STA 301 depending on the situation.

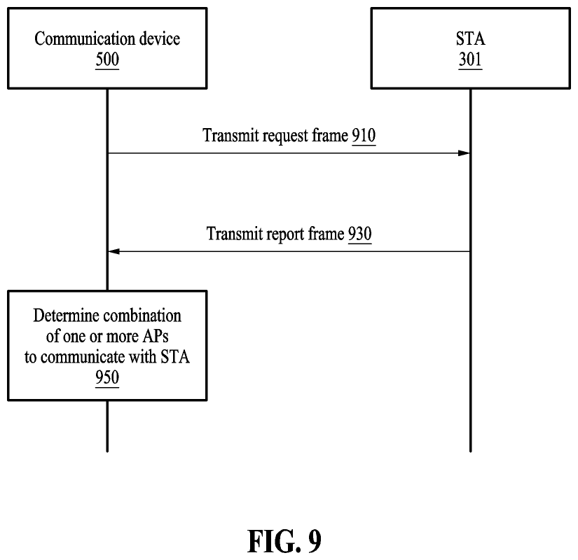

As described above with reference to FIG. 8, in a case where the communication device 500 collects feedback frames according to channel sounding and autonomously detects the location and/or mobility situation of the STA 301, the sensitivity of the movement detection) (e.g., how quickly the communication device 500 can detect the movement of the STA 301 when the STA 301 starts moving in s stationary state or vice versa) may be affected by the channel sounding operation period. When the channel sounding period decreases as the STA 301 starts moving, the communication device 500 may quickly detect the movement of the STA 301. However, for the natural decrease in the channel sounding period, transmission failure can be unavoidable, and it may take long to detect the same. As a method of detecting a movement start time of the STA 301 by the communication device 500 to supplement the foregoing, a method of specifying its mobility situation by the STA 301 and reporting the mobility situation to the communication device 500 will be described with reference to FIG. 9.

FIG. 9 is a diagram illustrating an example of a method of controlling multi-AP coordination using channel sounding according to an embodiment.

Referring to FIG. 9, operations 910 to 950 may be intended to describe the operation of the communication device 500 to control multi-AP coordination with assistance from the STA 301. Operations 910 to 950 may be sequentially performed, but are not necessarily performed sequentially. For example, the order of operations 910 to 950 may be changed, or at least two operations thereof may be performed in parallel.

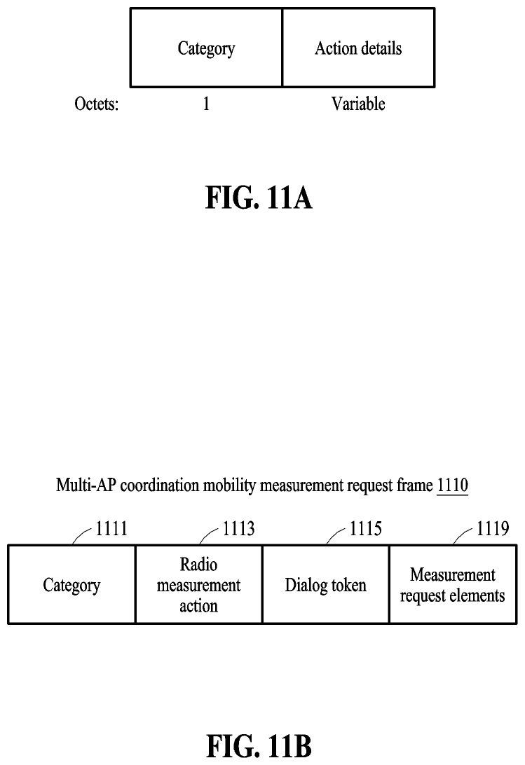

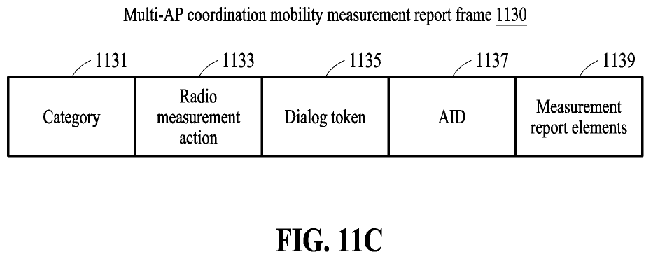

In operation 910, the communication device 500 may transmit, to the STA 301, a request frame (e.g., a multi-AP coordination mobility measurement request frame 1130 of FIG. 11A) to request reporting of state information of the STA 301. The state information of the STA 301 may include a combination of one or more of mobility information of the STA 301 or information indicating a wireless network environment of the STA 301. The state information of the STA 301 may be information specifying the location and/or mobility situation of the STA 301.

In operation 930, the STA 301 may transmit, to the communication device 500, a report frame (e.g., a multi-AP coordination mobility measurement report frame of FIG. 11B) containing state information of the STA 301. According to an embodiment, operation 910 may be omitted, and the STA 301 may autonomously report a response frame without a request from the communication device 500.

In operation 950, in response to the report frame, the communication device 500 may determine (or select) a combination of one or more APs to communicate with the STA 301 in a network environment for multi-AP coordination based on feedback frames collected according to channel sounding between the STA 301 and one or more devices capable of participating in multi-AP coordination. The communication device 500 may determine the location and mobility situation of the STA 301 from feedback frames collected with the assistance of the STA 301. The collected feedback frames may be feedback frames collected according to channel sounding performed before the report frame is received. Alternatively, channel sounding may be performed when the report frame is received, and the communication device 500 may collect feedback frames for channel sounding transmitted from the STA 301, and determine a combination of one or more APs to communicate with the STA 301 using the collected feedback frames.

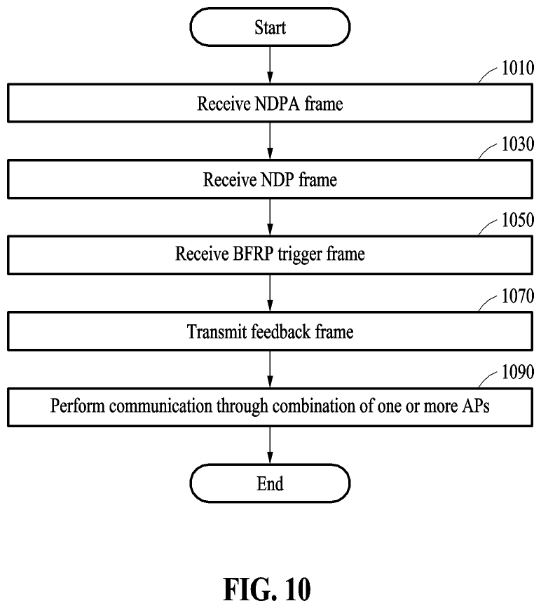

FIG. 10 is a diagram illustrating an operation of a station (STA) for multi-AP coordination according to an embodiment.

Referring to FIG. 10, operations 1010 to 1090 may be intended to describe the operation of the STA 301 for multi-AP coordination. Operations 1010 to 1090 may be sequentially performed, but are not necessarily performed sequentially. For example, the order of operations 1010 to 1090 may be changed, and at least two operations thereof may be performed in parallel.

In operation 1010, the STA 301 may receive an NDPA frame notifying channel sounding. In operation 1030, the STA 301 may receive an NDP frame. In operation 1050, the STA 301 may receive a BFRP trigger frame. In operation 1070, the STA 301 may transmit a feedback frame containing channel state information based on the BFRP trigger frame.

Operations 1010 to 1070 may be performed simultaneously or sequentially between the STA 301 and one or more devices capable of participating in multi-AP coordination. The one or more devices capable of participating in multi-AP coordination may include APs (e.g., the AP 401, the AP 403, and the AP 405) and/or the communication device 500.

In operation 1090, the STA 301 may perform communication through a combination of one or more APs determined based on the feedback frame in a network environment for multi-AP coordination. The STA 301 may perform communication by switching, according to the location and/or mobility situation of the STA 301, from a single AP to a multi-AP combination, or from a multi-AP combination to a single AP, or from a first multi-AP combination to a second multi-AP combination.

FIGS. 11A to 11C are diagrams illustrating frames defined to transfer a report of state information of STA according to an embodiment.

FIG. 11A shows an example embodiment of a request frame requesting reporting of state information of the STA 301 according to an embodiment, and FIG. 11B shows an example embodiment of a response frame specifying state information of the STA 301 according to an embodiment. The state information of the STA 301 may be information specifying the location and/or mobility situation of the STA 301. A multi-AP coordination mobility measurement request frame 1110 and a multi-AP coordination mobility measurement report frame 1130 may be frames defined to transmit state information of the STA 301 to the communication device 500. The multi-AP coordination mobility measurement request frame 1110 and the multi-AP coordination mobility measurement report frame 1130 may be defined using the radio measurement action frame of IEEE 802.11.

FIG. 11A shows an example embodiment of an action field included in the action frame defined in the 802.11 standard. The action frame may define and use various actions according to the category value of the action field. Table 2 shows the excerpt of a portion of the action frame defined according to the category value in the IEEE 802.11 standard, and the radio measurement action frame may be confirmed in Table 2.

TABLE 2

| | | | | Group |
|---|---|---|---|---|
| | | See | | addressed |
| Code | Meaning | subclause | Robust | privacy |
| 0 | Spectrum Management | 9.6.2 | Yes | No |
| 1 | QoS | 9.6.3 | Yes | No |
| 2 | DLS | 9.6.4 | Yes | No |
| 3 | Block Ack | 9.6.5 | Yes | No |
| 4 | Public | 9.6.8 | No | No |
| 5 | Radio Measurement | 9.6.7 | See | No |
| | | | NOTE 1 | |

According to an embodiment, the radio measurement action frame may operate as a pair of request/report and/or operate in an autonomous report manner. The role of the radio measurement action frame may be defined according to the value of a radio measurement action field of the radio measurement action frame. As shown in Table 3, six radio measurement action field values (e.g., values of “0” to “5”) are defined, and the radio measurement action frame may be defined and used to request a peer device to measure a wireless channel state or to request nearby AP information. The remaining values (e.g., values of “6” to “255”) may be left reserved.

TABLE 3

| Radio Measurement | |
|---|---|
| Action field value | Description |
| 0 | Radio Measurement Request |
| 1 | Radio Measurement Report |
| 2 | Link Measurement Request |
| 3 | Link Measurement Report |
| 4 | Neighbor Report Request |
| 5 | Neighbor Report Response |
| 6-255 | Reserved |

According to an embodiment, the multi-AP coordination mobility measurement request frame 1110 and the multi-AP coordination mobility measurement report frame 1130 of FIGS. 11B and 11C, respectively, may be defined (or designed) by setting the remaining values (e.g., the values of “6” to “255”) in the radio measurement action field of the radio measurement action frame. For example, if the radio measurement action field value is “6”, the radio measurement action frame may be defined as the multi-AP coordination mobility measurement request frame 1110, and an AP (e.g., the communication device 500) may use the multi-AP coordination mobility measurement request frame 1110 to request a period to update the mobility situation from a single client terminal (e.g., the STA 301). If the radio measurement action field value is “7”, the radio measurement action frame may be defined as the multi-AP coordination mobility measurement report frame 1130, and the single client terminal (e.g., the STA 301) may use the multi-AP coordination mobility measurement report frame 1130 to notify its mobility situation to the AP (e.g., the communication device 500). The AP (e.g., the communication device 500) may simultaneously transmit the multi-AP coordination mobility measurement request frame 1110 to a plurality of client terminals, and each client terminal may transmit the multi-AP coordination mobility measurement report frame 1130 to the AP (e.g., the communication device 500) in response to the multi-AP coordination mobility measurement request frame 1110.

According to an embodiment, the multi-AP coordination mobility measurement request frame 1110 and the multi-AP coordination mobility measurement report frame 1130 may operate as a pair of request/report or operate in an autonomous report manner.

According to an embodiment, the multi-AP coordination mobility measurement request frame 1110 may include a category field 1111, a radio measurement action field 1113, a dialog token field 1115, and a measurement request element field 1119. A category value (e.g., the category value “2” in Table 2) may be set in the category field 1111, and a radio measurement action field value (e.g., one of the radio measurement action field values “6” to “255” in Table 3) may be set in the radio measurement action field 1113. The dialog token field 1115 may be used to identify a measurement request transaction. For example, the AP (e.g., the communication device 500) may set the dialog token field 1115 as “1” at a time T1 and transmit the multi-AP coordination mobility measurement request frame 1110, and set the dialog token field 1115 as “2” at a time T2 and transmit the multi-AP coordination mobility measurement request frame 1110. The measurement request element field 1119 may contain request type information. For example, the request type may be an immediate response request, a measurement start request, and/or a measurement stop request.

According to an embodiment, the immediate response request type may be used in the operation mode of a request/report pair. When the AP (e.g., the communication device 500) transmits the multi-AP coordination mobility measurement request frame 1110 as an immediate response request type, the STA (e.g., the STA 301) may measure the current state and transmit the multi-AP coordination mobility measurement report frame 1130 to the AP (e.g., the communication device 500).

According to an embodiment, the measurement start request/measurement stop request type may be used in the operation mode of an autonomous report. When the STA (e.g., the STA 301) receives the multi-AP coordination mobility measurement request frame 1110 containing a measurement start request, the STA (e.g., the STA 301) may transmit the multi-AP coordination mobility measurement report frame 1130 to the AP (e.g., the communication device 500) each time when its location and/or mobility situation changes, until the multi-AP coordination mobility measurement request frame 1110 containing a measurement stop request is received by the STA (e.g., the STA 301). For example, when the STA (e.g., the STA 301) changes from a mobile state to a stationary state, contrary to the case of changing from a stationary state to a mobile state, the STA (e.g., the STA 301) may transmit the multi-AP coordination mobility measurement report frame 1130 to the AP (e.g., the communication device 500). Additionally, if the STA (e.g., the STA 301) is moving, the STA (e.g., the STA 301) may transmit the multi-AP coordination mobility measurement report frame 1130 when the moving speed changes or the SNRs of APs change. If the SNRs of APs change even in a stationary state, the STA (e.g., the STA 301) may transmit the multi-AP coordination mobility measurement report frame 1130. Upon receiving the multi-AP coordination mobility measurement request frame 1110 containing a measurement stop request from the AP (e.g., the communication device 500), the STA (e.g., the STA 301) may not transmit the multi-AP coordination mobility measurement report frame 1130 after that.

According to an embodiment, the multi-AP coordination mobility measurement report frame 1130 may include a category field 1131, a radio measurement action field 1133, a dialog token field 1135, an AID field 1137, and a measurement request element field 1139. A category value (e.g., the category value “2” in Table 2) may be set in the category field 1131, and a radio measurement action field value (e.g., one of the radio measurement action field values “6” to “255” in Table 3) may be set in the radio measurement action field 1133. The dialog token field 1135 may be used to identify a measurement report transaction. For example, the STA (e.g., the STA 301) may set the dialog token field 1135 and transmit the multi-AP coordination mobility measurement report frame 1130. The AP (e.g., the communication device 500) may verify the time when the result was measured by checking the dialog token field 1135 of the multi-AP coordination mobility measurement report frame 1130. STA identifier information in the corresponding network may be set in the AID field 1137. The measurement request element field 1139 may contain the mobility information of the STA (e.g., the STA 301) and information indicating the wireless network environment. For example, the mobility information may include mobility situation information (e.g., a stationary or mobile state) and/or a moving speed level (e.g., whether running is performed or walking is performed). The information indicating the wireless network environment may include an AP identifier (e.g., BSSID) and SNR information (e.g., SNR information of the AP). In some embodiments, the SNR information may be mapped to the AP identifier.

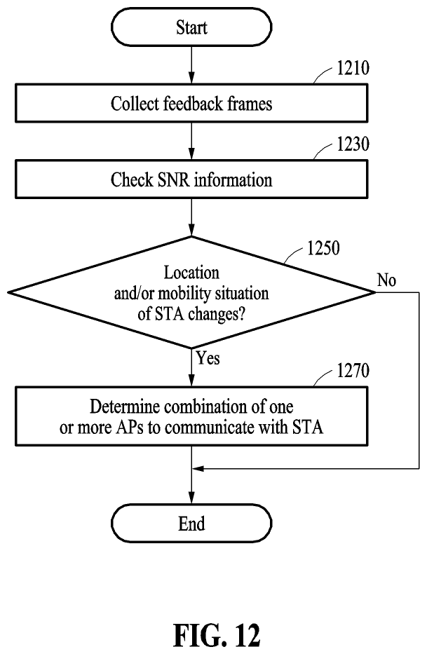

FIG. 12 is a diagram illustrating an example of controlling multi-AP coordination using channel sounding according to an embodiment.

Operations 1210 to 1270 may be performed sequentially, but are not necessarily performed sequentially. For example, the order of operations 1210 to 1270 may be changed, and at least two operations thereof may be performed in parallel.

In operation 1210, the communication device 500 may collect feedback frames for channel sounding transmitted from the STA 301. The feedback frames may include feedback frames between the STA 301 and one or more devices capable of participating in multi-AP coordination. The one or more devices capable of participating in multi-AP coordination may include APs (e.g., the AP 401, the AP 403, and the AP 405) and/or the communication device 500.

In operation 1230, the communication device 500 may check, from the feedback frames, SNR information of one or more devices capable of participating in multi-AP coordination from the perspective of the STA 301.

In operation 1250, the communication device 500 may determine whether the location and/or mobility situation of the STA 301 changes, based on the SNR information of the one or more devices capable of participating in multi-AP coordination. From this SNR information, the communication device 500 may verify a change in the location and/or mobility situation of the STA 301 compared to before, by verifying the tendency of changes in signals received by the STA 301 from the devices capable of participating in multi-AP coordination.

In operation 1270, when the location or mobility situation of the STA 301 changes, the communication device 500 may determine (or select) a combination of one or more APs to participate in data transmission and reception (e.g., an optimal combination of APs to communicate with the STA 301) in a network environment for multi-AP coordination.

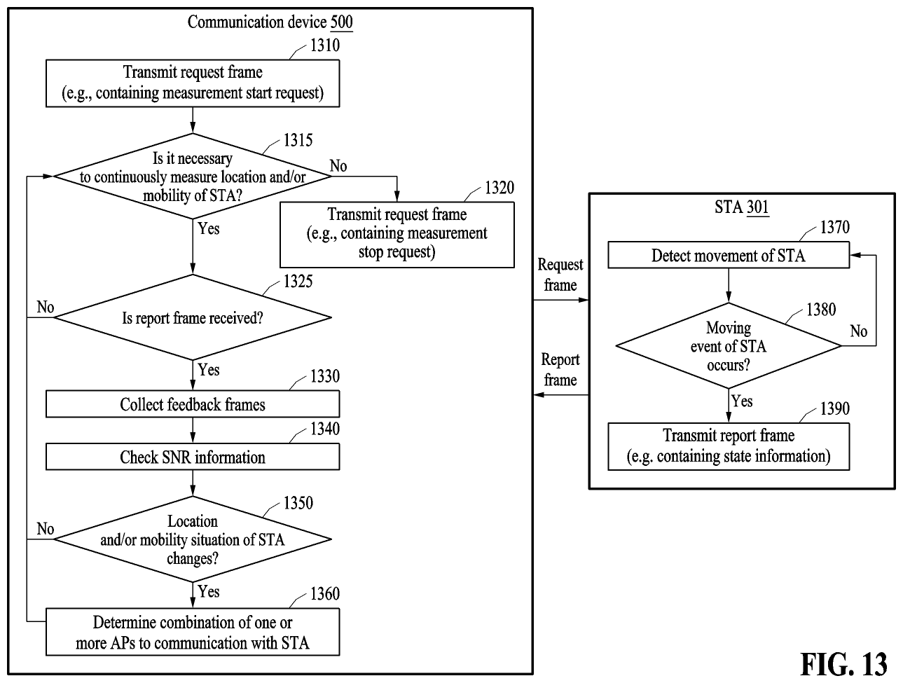

FIG. 13 is a diagram illustrating an example embodiment of controlling multi-AP coordination using channel sounding according to an embodiment.

Operations 1310 to 1360 may be performed by the communication device 500, and operations 1370 to 1390 may be performed by the STA 301. Operations 1310 to 1360 and operations 1370 to 1390 may be performed sequentially, but are not necessarily performed sequentially. For example, the order of operations 1310 to 1360 and the order of operations 1370 to 1390 may be changed, and at least two operations thereof may be performed in parallel. For ease of description, the operation of the communication device 500 will be described, and then the operation of the STA 301 will be described.

### Operation of Communication Device 500

In operation 1310, the communication device 500 may transmit a multi-AP coordination mobility measurement request frame (e.g. the multi-AP coordination mobility measurement request frame 1110 of FIG. 11B above) containing a measurement start request to the STA 301. The multi-AP coordination mobility measurement request frame 1110 containing the measurement start request may be intended to request the STA 301 to transmit (e.g., including updating) information about the location and/or mobility situation of the STA 301. The measurement start request may be contained in the measurement request element field 1119 of the multi-AP coordination mobility measurement request frame 1110.

In operation 1315, the communication device 500 may determine whether it is necessary or optimal to continuously measure the location and/or mobility of the STA 301. If it is necessary or optimal to continuously measure the mobility of the STA 301, the communication device 500 may perform operation 1325. Otherwise, the communication device 500 may perform operation 1320.

In operation 1320, in response to the determination that it is necessary to continuously measure the location and/or mobility of the STA 301, the communication device 500 may transmit a multi-AP coordination mobility measurement request frame 1110 containing a measurement stop request to the STA 301. The measurement stop request may be contained in the measurement request element field 1119 of the multi-AP coordination mobility measurement request frame 1110.

In operation 1325, the communication device 500 may verify whether the multi-AP coordination mobility measurement report frame 1130 transmitted from the STA 301 is received.

In operation 1330, when the multi-AP coordination mobility measurement report frame 1130 is received, the communication device 500 may collect feedback frames for channel sounding transmitted from the STA 301. The feedback frames may include feedback frames between the STA 301 and one or more devices capable of participating in multi-AP coordination. The one or more devices capable of participating in multi-AP coordination may include APs (e.g., the AP 401, the AP 403, and the AP 405) and/or the communication device 500.

In operation 1340, the communication device 500 may check SNR information of APs (e.g., the AP 401, the AP 403, and the AP 405) from the perspective of the STA 301, from the feedback frames (e.g., a feedback frame between the AP 401 and the STA 301, a feedback frame between the AP 403 and the STA 301, and a feedback frame between the AP 405 and the STA 301).

In operation 1350, the communication device 500 may determine whether the location and/or mobility situation of the STA 301 changes, based on the SNR information of one or more devices capable of participating in multi-AP coordination. From this SNR information, the communication device 500 may verify a change in the location and/or mobility situation of the STA 301 compared to before, by verifying the tendency of changes in signals received by the STA 301 from the devices capable of participating in multi-AP coordination.

In operation 1360, when the location and/or mobility situation of the STA 301 changes, the communication device 500 may determine (or select) a combination of one or more APs to participate in data transmission and reception (e.g., an optimal combination of APs to communicate with the STA 301) in a network environment for multi-AP coordination.

### Operation of STA 301

In operations 1370 and 1380, the STA 301 may detect a movement of the STA 301 in response to the multi-AP coordination mobility measurement request frame 1110 containing the measurement start request, and determine whether a moving event of the STA 301 occurs based on a movement detection result. Detecting the movement of the STA 301 may be initiated according to the multi-AP coordination mobility measurement request frame 1110 containing the measurement start request. The STA 301 may detect the movement of the STA 301 based on a change in the signal intensity of the AP and/or sensor information from a sensor (e.g., an inertial sensor) for detecting a movement in the STA 301.

In operation 1390, when a moving event of the STA 301 occurs, the STA 301 may transmit, to the communication device 500, a multi-AP coordination mobility measurement report frame 1130 containing state information of the STA 301 specifying the location and/or mobility situation of the STA 301.

When a multi-AP coordination mobility measurement request frame 1110 including a measurement stop request is received from the communication device 500, the STA 301 may stop detecting the movement of the STA 301. That is, the STA 301 may stop transmitting the multi-AP coordination mobility measurement report frame 1130 to the communication device 500.

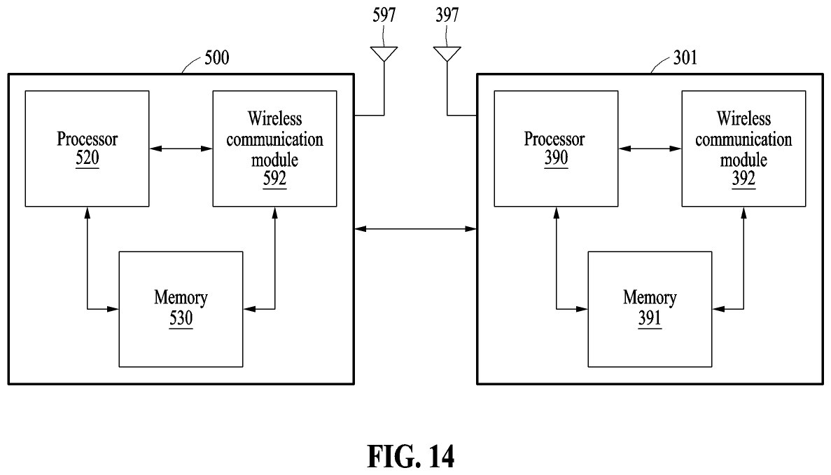

FIG. 14 is a schematic block diagram of a WLAN system for multi-AP coordination according to an embodiment.

Referring to FIG. 14, a WLAN system (e.g., the WLAN system 10 of FIG. 1, the WLAN system 20 of FIG. 2, or the WLAN system 30 of FIG. 4) may include the communication device 500 and the STA. 301 (e.g., the electronic device 1501, the electronic device 1502, or the electronic device 1504 of FIG. 15).

According to an embodiment, the communication device 500 may include a processor 520, a memory 530, a wireless communication module 592, and an antenna module 597. The processor 520 may be operatively connected to the wireless communication module 592. The wireless communication module 592 may be configured to transmit and receive wireless signals, and may transmit or receive wireless signals through the antenna module 597. The processor 520 may be electrically connected to the memory 530, and may execute instructions stored in the memory 530.

According to an embodiment, the memory 530 may include one or more memories. The instructions stored in the memory 530 may be stored in a single memory. The instructions stored in the memory 530 may be distributed and stored in a plurality of memories. The instructions stored in the memory 530 may be executed individually or collectively by the processor 520 to cause the communication device 500 to perform and/or control the operation of the communication device 500 described with reference to FIGS. 4 to 13.

According to an embodiment, the processor 520 may be implemented as circuitry (e.g., processing circuitry) such as a system-on-chip (SoC) or an integrated circuit (IC). The processor 520 may include one or more processors. For example, the processor 520 may include a combination of one or more processors such as a CPU, a GPU, an MPU, an application processor, and a communication processor (CP). The instructions stored in the memory 530 may be executed individually or collectively by a single processor to cause the communication device 500 to perform and/or control the operation of the communication device 500 described with reference to FIGS. 4 to 13. The instructions stored in the memory 530 may be executed individually or collectively by a plurality of processors to cause the communication device 500 to perform and/or control the operation of the communication device 500 described with reference to FIGS. 4 to 13.

According to an embodiment, the STA 301 may include a processor 390 (e.g., a processor 1520 of FIG. 15), a memory 391 (e.g., a memory 1530 of FIG. 15), a wireless communication module 392 (e.g., a wireless communication module 1592 of FIG. 15), and an antenna module 397 (e.g., an antenna module 1597 of FIG. 15). The processor 390 may be operatively connected to the wireless communication module 392. The wireless communication module 392 may be configured to transmit and receive wireless signals, and may transmit or receive wireless signals through the antenna module 397. The processor 390 may be electrically connected to the memory 391, and may execute instructions stored in the memory 391. The memory 391 may store one or more instructions executable by the processor 390. The one or more instructions stored in the memory 391 may be executed individually or collectively by the processor 390 to cause the STA 301 to control the operation of the STA 301 described with reference to FIGS. 4 to 13.

According to an embodiment, the memory 391 may include one or more memories. The instructions stored in the memory 391 may be stored in a single memory. The instructions stored in the memory 391 may be distributed and stored in a plurality of memories. The instructions stored in the memory 391 may be executed individually or collectively by the processor 390 to cause the STA 301 to perform and/or control the operation of the STA 301 described with reference to FIGS. 4 to 13.

According to an embodiment, the processor 390 may be implemented as circuitry (e.g., processing circuitry) such as a system-on-chip (SoC) or an integrated circuit (IC). The processor 390 may include one or more processors. For example, the processor 390 may include a combination of one or more processors such as a CPU, a GPU, an MPU, an application processor, and a communication processor (CP). The instructions stored in the memory 391 may be executed individually or collectively by a single processor to cause the STA 301 to perform and/or control the operation of the STA 301 described with reference to FIGS. 4 to 13. The instructions stored in the memory 391 may be executed individually or collectively by a plurality of processors to cause the STA 301 to perform and/or control the operation of the STA 301 described with reference to FIGS. 4 to 13.

FIG. 15 is a block diagram of an electronic device 1501 in a network environment 1500 according to various embodiments. Referring to FIG. 15, an electronic device 1501 in a network environment 1500 may communicate with an electronic device 1502 via a first network 1598 (e.g., a short-range wireless communication network), or at least one of an electronic device 1504 or a server 1508 via a second network 1599 (e.g., a long-range wireless communication network). According to an embodiment, the electronic device 1501 may communicate with the electronic device 1504 via the server 1508. According to an embodiment, the electronic device 1501 may include a processor 1520, a memory 1530, an input module 1550, a sound output module 1555, a display module 1560, an audio module 1570, a sensor module 1576, an interface 1577, a connecting terminal 1578, a haptic module 1579, a camera module 1580, a power management module 1588, a battery 1589, a communication module 1590, a subscriber identification module (SIM) 1596, or an antenna module 1597. In some embodiments, at least one of the components (e.g., the connecting terminal 1578) may be omitted from the electronic device 1501, or one or more other components may be added in the electronic device 1501. In some embodiments, some of the components (e.g., the sensor module 1576, the camera module 1580, or the antenna module 1597) may be implemented as a single component (e.g., the display module 1560).

The processor 1520 may execute, for example, software (e.g., a program 1540) to control at least one other component (e.g., a hardware or software component) of the electronic device 1501 coupled with the processor 1520, and may perform various data processing or computation. According to an embodiment, as at least a part of data processing or computation, the processor 1520 may store a command or data received from another component (e.g., the sensor module 1576 or the communication module 1590) in a volatile memory 1532, process the command or the data stored in the volatile memory 1532, and store resulting data in a non-volatile memory 1534. According to an embodiment, the processor 1520 may include a main processor 1521 (e.g., a central processing unit (CPU) or an application processor) or an auxiliary processor 1523 (e.g., a graphics processing unit (GPU), a neural processing unit (NPU), an image signal processor (ISP), a sensor hub processor, or a communication processor (CP)) that is operable independently from, or in conjunction with, the main processor 1521. For example, when the electronic device 1501 includes the main processor 1521 and the auxiliary processor 1523, the auxiliary processor 1523 may be adapted to consume less power than the main processor 1521, or to be specific to a specified function. The auxiliary processor 1523 may be implemented as separate from, or as part of the main processor 1521.

The auxiliary processor 1523 may control at least some of functions or states related to at least one component (e.g., the display module 1560, the sensor module 1576, or the communication module 1590) among the components of the electronic device 1501, instead of the main processor 1521 while the main processor 1521 is in an inactive (e.g., sleep) state, or together with the main processor 1521 while the main processor 1521 is in an active state (e.g., executing an application). According to an embodiment, the auxiliary processor 1523 (e.g., an ISP or a CP) may be implemented as a portion of another component (e.g., the camera module 1580 or the communication module 1590) that is functionally related to the auxiliary processor 1523. According to an embodiment, the auxiliary processor 1523 (e.g., an NPU) may include a hardware structure specified for processing of an artificial intelligence (AI) model. An artificial intelligence model may be generated by machine learning. Such learning may be performed, e.g., by the electronic device 1501 where the artificial intelligence is performed, or via a separate server (e.g., the server 1508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network, or a combination of two or more thereof, but is not limited thereto. The artificial intelligence model may, additionally or alternatively, include a software structure other than the hardware structure.

The memory 1530 may store various data used by at least one component (e.g., the processor 1520 or the sensor module 1576) of the electronic device 1501. The various data may include, for example, software (e.g., the program 1540) and input data or output data for a command related thereto. The memory 1530 may include the volatile memory 1532 or the non-volatile memory 1534.

The program 1540 may be stored in the memory 1530 as software, and may include, for example, an operating system (OS) 1542, middleware 1544, or an application 1546.

The input module 1550 may receive a command or data to be used by another component (e.g., the processor 1520) of the electronic device 1501, from the outside (e.g., a user) of the electronic device 1501. The input module 1550 may include, for example, a microphone, a mouse, a keyboard, a key (e.g., a button), or a digital pen (e.g., a stylus pen).

The sound output module 1555 may output sound signals to the outside of the electronic device 1501. The sound output module 1555 may include, for example, a speaker or a receiver. The speaker may be used for general purposes, such as playing multimedia or playing a record. The receiver may be used to receive an incoming call. According to an embodiment, the receiver may be implemented separately from the speaker or as a part of the speaker.

The display module 1560 may visually provide information to the outside (e.g., a user) of the electronic device 1501. The display module 1560 may include, for example, a display, a hologram device, or a projector and control circuitry to control a corresponding one of the display, hologram device, and projector. According to an embodiment, the display module 1560 may include a touch sensor adapted to detect a touch, or a pressure sensor adapted to measure the intensity of force incurred by the touch.

The audio module 1570 may convert a sound into an electrical signal and vice versa. According to an embodiment, the audio module 1570 may obtain the sound via the input module 1550, or output the sound via the sound output module 1555 or an external electronic device (e.g., the electronic device 1502 such as a speaker or a headphone) directly or wirelessly connected to the electronic device 1501.

The sensor module 1576 may detect an operational state (e.g., power or temperature) of the electronic device 1501 or an environmental state (e.g., a state of a user) external to the electronic device 1501, and then generate an electrical signal or data value corresponding to the detected state. According to an embodiment, the sensor module 1576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1577 may support one or more specified protocols to be used for the electronic device 1501 to be coupled with the external electronic device (e.g., the electronic device 1502) directly (e.g., wiredly) or wirelessly. According to an embodiment, the interface 1577 may include, for example, a high-definition multimedia interface (HDMI), a universal serial bus (USB) interface, a secure digital (SD) card interface, or an audio interface.

The connecting terminal 1578 may include a connector via which the electronic device 1501 may be physically connected with the external electronic device (e.g., the electronic device 1502). According to an embodiment, the connecting terminal 1578 may include, for example, an HDMI connector, a USB connector, an SD card connector, or an audio connector (e.g., a headphone connector).

The haptic module 1579 may convert an electrical signal into a mechanical stimulus (e.g., a vibration or a movement) or electrical stimulus which may be recognized by a user via his tactile sensation or kinesthetic sensation. According to an embodiment, the haptic module 1579 may include, for example, a motor, a piezoelectric element, or an electric stimulator.

The camera module 1580 may capture a still image and moving images. According to an embodiment, the camera module 1580 may include one or more lenses, image sensors, image signal processors, or flashes.

The power management module 1588 may manage power supplied to the electronic device 1501. According to an embodiment, the power management module 1588 may be implemented as, for example, at least a part of a power management integrated circuit (PMIC).

The battery 1589 may supply power to at least one component of the electronic device 1501. According to an embodiment, the battery 1589 may include, for example, a primary cell which is not rechargeable, a secondary cell which is rechargeable, or a fuel cell.

The communication module 1590 may support establishing a direct (e.g., wired) communication channel or a wireless communication channel between the electronic device 1501 and the external electronic device (e.g., the electronic device 1502, the electronic device 1504, or the server 1508) and performing communication via the established communication channel. The communication module 1590 may include one or more communication processors that are operable independently from the processor 1520 (e.g., the application processor) and support direct (e.g., wired) communication or wireless communication. According to an embodiment, the communication module 1590 may include a wireless communication module 1592 (e.g., a cellular communication module, a short-range wireless communication module, or a global navigation satellite system (GNSS) communication module) or a wired communication module 1594 (e.g., a local area network (LAN) communication module, or a power line communication (PLC) module). A corresponding one of these communication modules may communicate with the external electronic device 1504 via the first network 1598 (e.g., a short-range communication network, such as Bluetooth™, wireless-fidelity (Wi-Fi) direct, or infrared data association (IrDA)) or the second network 1599 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 1592 may identify and authenticate the electronic device 1501 in a communication network, such as the first network 1598 or the second network 1599, using subscriber information (e.g., international mobile subscriber identity (IMSI)) stored in the SIM 1596.

The wireless communication module 1592 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1592 may support a high-frequency band (e.g., a mmWave band) to achieve, e.g., a high data transmission rate. The wireless communication module 1592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1592 may support various requirements specified in the electronic device 1501, an external electronic device (e.g., the electronic device 1504), or a network system (e.g., the second network 1599). According to an embodiment, the wireless communication module 1592 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1597 may transmit or receive a signal or power to or from the outside (e.g., the external electronic device) of the electronic device 1501. According to an embodiment, the antenna module 1597 may include an antenna including a radiating element including a conductive material or a conductive pattern formed in or on a substrate (e.g., a printed circuit board (PCB)). According to an embodiment, the antenna module 1597 may include a plurality of antennas (e.g., array antennas). In such a case, at least one antenna appropriate for a communication scheme used in the communication network, such as the first network 1598 or the second network 1599, may be selected, for example, by the communication module 1590 from the plurality of antennas. The signal or the power may be transmitted or received between the communication module 1590 and the external electronic device via the selected at least one antenna. According to an embodiment, another component (e.g., a radio frequency integrated circuit (RFIC)) other than the radiating element may be additionally formed as part of the antenna module 1597.

According to various embodiments, the antenna module 1597 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mm Wave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1501 and the external electronic device 1504 via the server 1508 coupled with the second network 1599. Each of the external electronic devices 1502 and 1504 may be a device of a same type as, or a different type from, the electronic device 1501. According to an embodiment, all or some of operations to be executed by the electronic device 1501 may be executed at one or more external electronic devices (e.g., the external devices 1502 and 1504, and the server 1508). For example, if the electronic device 1501 should perform a function or a service automatically, or in response to a request from a user or another device, the electronic device 1501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1501. The electronic device 1501 may provide the outcome, with or without further processing of the outcome, as at least part of a reply to the request. To that end, a cloud computing, distributed computing, mobile edge computing (MEC), or client-server computing technology may be used, for example. The electronic device 1501 may provide ultra low-latency services using, e.g., distributed computing or mobile edge computing. In another embodiment, the external electronic device 1504 may include an Internet-of-things (IoT) device. The server 1508 may be an intelligent server using machine learning and/or a neural network. According to an embodiment, the external electronic device 1504 or the server 1508 may be included in the second network 1599. The electronic device 1501 may be applied to intelligent services (e.g., smart home, smart city, smart car, or healthcare) based on 5G communication technology or IoT-related technology.

According to an embodiment, an electronic device (e.g., the STA 301 of FIG. 4 or the electronic device 1501 of FIG. 15) may include a processor (e.g., the processor 390 of FIG. 14 or the processor 1520 of FIG. 15), at least one wireless communication circuit (e.g., the wireless communication module 392 of FIG. 14 or the wireless communication module 1592 of FIG. 15) operatively connected to the processor 390 or 1520 and configured to transmit and receive a wireless signal, and a memory (e.g., the memory 391 of FIG. 14 or the memory 1530 of FIG. 15) configured to store instructions. The instructions may be executed individually or collectively by the processor 390 or 1520 to cause the electronic device 301 or 1501 to receive an NDPA frame notifying channel sounding. The instructions may be executed individually or collectively by the processor 390 or 1520 to cause the electronic device 301 or 1501 to receive an NDP frame. The instructions may be executed individually or collectively by the processor 390 or 1520 to cause the electronic device 301 or 1501 to obtain channel state information based on the NDP frame. The instructions may be executed individually or collectively by the processor 390 or 1520 to cause the electronic device 301 or 1501 to receive a BFRP frame. The instructions may be executed individually or collectively by the processor 390 or 1520 to cause the electronic device 301 or 1501 to transmit a feedback frame comprising the obtained channel state information based on the BFRP frame. The instructions may be executed individually or collectively by the processor 390 or 1520 to cause the electronic device 301 or 1501 to perform communication through a combination of one or more APs determined based on the feedback frame in a network environment for multi-AP coordination.

According to an embodiment, the instructions may be executed individually or collectively by the processor 390 or 1520 to further cause the electronic device 301 or 1501 to further report state information of the electronic device 301 or 1501 to a device 500 for controlling multi-AP coordination.

According to an embodiment, the state information may include a combination of one or more of mobility information of the electronic device 301 or 1501, or information indicating a wireless network environment of the electronic device 301 or 1501.

According to an embodiment, to report the state information, the instructions may be executed by the processor to report the state information according to an autonomous report or to request reporting of the state information from the device 500 for controlling multi-AP coordination.

According to an embodiment, to report the state information and to request reporting of the state information, a radio measurement action frame may be used.

According to an embodiment, the combination of one or more APs may be determined based on SNR information of one or more APs capable of participating in multi-AP coordination obtained from the feedback frame.

According to an embodiment, a protocol of the channel sounding may be triggered according to the reporting of the state information.

According to an embodiment, the instructions may be executed individually or collectively by the processor 390 or 1520 to further cause the electronic device 301 or 1501 to perform communication by switching from a single AP to a multi-AP combination.

According to an embodiment, the instructions may be executed individually or collectively by the processor 390 or 1520 to further cause the electronic device 301 or 1501 to perform communication by switching from a first multi-AP combination to a second multi-AP combination.

According to an embodiment, the instructions may be executed individually or collectively by the processor 390 or 1520 to further cause the electronic device 301 or 1501 to perform communication by switching from a multi-AP combination to a single AP.

According to an embodiment, a communication device (e.g., the communication device 500 of FIG. 4) for controlling multi-AP coordination may include a processor (e.g., the processor 520 of FIG. 14), at least one wireless communication circuit (e.g., the wireless communication module 592 of FIG. 14) operatively connected to the processor 520 and configured to transmit and receive a wireless signal, and a memory (e.g., the memory 530 of FIG. 14) configured to store instructions. The instructions may be executed individually or collectively by the processor 520 to cause the communication device 500 to collect feedback frames according to channel sounding between APs capable of participating in multi-AP coordination and an electronic device (e.g., the STA 301 of FIG. 4 or the electronic device 1501 of FIG. 15). The instructions may be executed individually or collectively by the processor 520 to cause the communication device 500 to determine a combination of one or more APs to communicate with the electronic device 301 or 1501 based on the feedback frames.

According to an embodiment, the instructions may be executed individually or collectively by the processor 520 to cause the communication device 500 to further request reporting of state information of the electronic device 301 or 1501.

According to an embodiment, the state information may include a combination of one or more of mobility information of the electronic device 301 or 1501, or information indicating a wireless network environment of the electronic device 301 or 1501.

According to an embodiment, to report the state information and to request reporting of the state information, a radio measurement action frame may be used.

According to an embodiment, a radio measurement action field value of the radio measurement action frame may be set to a value between 6 and 255.

According to an embodiment, the instructions may be executed individually or collectively by the processor 520 to further cause the communication device 500 to obtain SNR information of the APs capable of participating in multi-AP coordination from the feedback frames, and determine the combination of one or more APs to communicate with the electronic device 301 or 1501 based on the SNR information.

According to an embodiment, a protocol of the channel sounding may be triggered according to the reporting of the state information.

According to an embodiment, the instructions may be executed individually or collectively by the processor 520 to further cause the communication device 500 to switch the combination of one or more APs from a single AP to a multi-AP combination.

According to an embodiment, the instructions may be executed individually or collectively by the processor 520 to further cause the communication device 500 to switch the combination of one or more APs from a first multi-AP combination to a second multi-AP combination.

According to an embodiment, the instructions may be executed individually or collectively by the processor 520 to further cause the communication device 500 to switch the combination of one or more APs from a multi-AP combination to a single AP.

According to an embodiment, an operating method of an electronic device (e.g., the STA 301 of FIG. 4 or the electronic device 1501 of FIG. 15) may include receiving an NDPA frame notifying channel sounding. The operating method may include receiving an NDP frame. The operating method may include obtaining channel state information based on the NDP frame. The operating method may include receiving a BFRP frame. The operating method may include transmitting a feedback frame containing the channel state information based on the BFRP frame. The operating method may include performing communication through a combination of one or more APs determined based on the feedback frame in a network environment for multi-AP coordination.

The effects to be achieved are not limited to those described above, and other effects not mentioned above will be clearly understood by one of ordinary skill in the art from the description of this document.

The electronic device according to various embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms such as “1^{st},” and “2^{nd},” or “first” and “second” may be used to simply distinguish a corresponding component from another, and do not limit the components in other aspect (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., wiredly), wirelessly, or via a third component.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1540) including one or more instructions that are stored in a storage medium (e.g., internal memory 1536 or external memory 1538) that is readable by a machine (e.g., the electronic device 1501). For example, a processor (e.g., the processor 1520) of the machine (e.g., the electronic device 1501) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least portion of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
a processor;
a wireless communication circuit operatively connected to the processor, the wireless communication circuit configured to transmit and receive a wireless signal; and
a memory configured to store instructions, wherein
the instructions are executed individually or collectively by the processor to cause the electronic device to:
receive a null data packet announcement (NDPA) frame notifying channel sounding;
receive a null data packet (NDP) frame;
obtain channel state information based on the NDP frame;
receive a beamforming report poll (BFRP) frame;
transmit a feedback frame comprising the obtained channel state information based on the BFRP frame; and
perform communication through a combination of one or more access points (APs) determined based on the feedback frame in a network environment for multi-AP coordination.

2. The electronic device of claim 1, wherein the instructions are executed individually or collectively by the processor to further cause the electronic device to report state information of the electronic device to a device for controlling multi-AP coordination.

3. The electronic device of claim 2, wherein the state information comprises a combination of one or more of:
mobility information of the electronic device; or
information indicating a wireless network environment of the electronic device.

4. The electronic device of claim 2, wherein to report the state information, the instructions are executed by the processor to report the state information according to an autonomous report or to request reporting of the state information from the device for controlling multi-AP coordination.

5. The electronic device of claim 2, wherein to report the state information and to request reporting of the state information, a radio measurement action frame is used.

6. The electronic device of claim 1, wherein the combination of one or more APs is determined based on signal-to-noise ratio (SNR) information of one or more APs capable of participating in multi-AP coordination obtained from the feedback frame.

7. The electronic device of claim 2, wherein a protocol of the channel sounding is triggered according to the report of the state information.

8. The electronic device of claim 1, wherein the instructions are executed individually or collectively by the processor to further cause the electronic device to perform communication by switching from a single AP to a multi-AP combination.

9. The electronic device of claim 1, wherein the instructions are executed individually or collectively by the processor to further cause the electronic device to perform communication by switching from a first multi-AP combination to a second multi-AP combination.

10. The electronic device of claim 1, wherein the instructions are executed individually or collectively by the processor to further cause the electronic device to perform communication by switching from a multi-AP combination to a single AP.

11. A communication device for controlling multi-access point (AP) coordination, the communication device comprising:
a processor;
a wireless communication circuit operatively connected to the processor, the wireless communication circuit configured to transmit and receive a wireless signal; and
a memory configured to store instructions, wherein
the instructions are executed individually or collectively by the processor to cause the communication device to:
collect feedback frames according to channel sounding between APs and an electronic device, wherein the APs are capable of participating in multi-AP coordination; and
determine a combination of one or more APs to communicate with the electronic device based on the feedback frames.

12. The communication device of claim 11, wherein the instructions are executed individually or collectively by the processor to further cause the communication device to request reporting of state information of the electronic device.

13. The communication device of claim 12, wherein the state information comprises a combination of one or more of:
mobility information of the electronic device; or
information indicating a wireless network environment of the electronic device.

14. The communication device of claim 12, wherein to report the state information and to request reporting of the state information, a radio measurement action frame is used.

15. The communication device of claim 14, wherein a radio measurement action field value of the radio measurement action frame is set to a value between 6 and 255.

16. The communication device of claim 11, wherein the instructions are executed individually or collectively by the processor to further cause the communication device to:
obtain signal-to-noise ratio (SNR) information of the APs capable of participating in multi-AP coordination from the feedback frames; and
determine the combination of one or more APs to communicate with the electronic device based on the SNR information.

17. The communication device of claim 11, wherein the instructions are executed individually or collectively by the processor to further cause the communication device to switch the combination of one or more APs from a single AP to a multi-AP combination.

18. The communication device of claim 11, wherein the instructions are executed individually or collectively by the processor to further cause the communication device to switch the combination of one or more APs from a first multi-AP combination to a second multi-AP combination.

19. The communication device of claim 11, wherein the instructions are executed individually or collectively by the processor to further cause the communication device to switch the combination of one or more APs from a multi-AP combination to a single AP.

20. An operating method of an electronic device, the operating method comprising:
receiving a null data packet announcement (NDPA) frame notifying channel sounding;
receiving a null data packet (NDP) frame;
obtaining channel state information based on the NDP frame;
receiving a beamforming report poll (BFRP) frame;
transmitting a feedback frame comprising the obtained channel state information based on the BFRP frame; and
performing communication through a combination of one or more access points (APs) determined based on the feedback frame in a network environment for multi-AP coordination.
